(19) United States
(12) Patent Application Publication
(10) Pub. No.: US 2025/0067254 A1
(43) Pub. Date: Feb. 27, 2025

(54) System And Method For Improved Resistance Welding Electrode Life

(71) Applicant: Hutchinson Technology Incorporated, Hutchinson, MN (US)

(72) Inventors: Jason J. Idso, Litchfield, MN (US); John A. Rickeman, Darwin, MN (US); Jeremy J. Stroschein, Waconia, MN (US)

(21) Appl. No.: 18/812,143

(22) Filed: Aug. 22, 2024

Related U.S. Application Data
(60) Provisional application No. 63/534,718, filed on Aug. 25, 2023.

(51) Int. Cl. F03G 7/00; B23K 11/00; B23K 11/20; B23K 103/18; F03G 7/06

(52) U.S. Cl. CPC F03G 7/029; B23K 11/002; B23K 11/20; B23K 2103/18; F03G 7/06143

(57) ABSTRACT

A shape memory alloy (SMA) actuator can include an element (e.g., an SMA wire) configured to actuate when provided a current. The SMA element can be joined to the beam (e.g., made of stainless steel) using a resistance welding process that includes joining two metals by passing electrical current through them. A resistance welder, with smaller step sizes of power, lower total power, smaller step sizes of electrode clamp force, and lower time to time variability can produce additional test samples. Further, an approach can be taken to rebalance the heat of the system. The bottom electrode resistance (R6) can be increased by changing the electrode material from tungsten copper to a more resistive tungsten alloy. Further, a tungsten alloy can be used. The short duration pulse weld recipe with the higher resistivity bottom electrode can be the baseline resistance welding process for attaching SMA wire to stainless steel.

### CROSS-REFERENCE TO RELATED APPLICATIONS

This application claims the benefit of, and priority to, U.S. Provisional Application No. 63/534,718 filed on Aug. 25, 2023, which is hereby incorporated by reference in its entirety.

### FIELD

The invention relates generally to performing resistance welding between metals, and more particularly, to improved methods for performing resistance welding between a metal actuator and a shape memory alloy material.

### BACKGROUND

An actuator can be used in a variety of contexts. For example, an actuator can move a lens back and forth to focus the lens as part of an autofocus system. In many cases, it can be desirable to move a moving component in a desired direction (e.g., a Z direction) to increase efficiency in implementing such an autofocus system.

A shape memory alloy (SMA) actuator can include an element (e.g., an SMA wire) configured to actuate when provided a current. Such actuation can be used to move an object, such as a moving carriage or lens in an autofocus (AF) or optical image stabilization (OIS) system in an imaging device. The SMA element can be an alloy of nickel and titanium (commonly called nitinol).

The SMA element can be joined to the beam (e.g., made of stainless steel) using a resistance welding process that includes joining two metals by passing electrical current through them to create joule heating so that the two materials bond together. The SMA wire and stainless steel can be squeezed between opposing electrodes and current is delivered through the electrodes to create joule heating.

### SUMMARY

A shape memory alloy (SMA) actuator can include an element (e.g., an SMA wire) configured to actuate when provided a current. The SMA element can be joined to the beam (e.g., made of stainless steel) using a resistance welding process that includes joining two metals by passing electrical current through them to bond them together. A resistance welder, with smaller step sizes of power, lower total power, smaller step sizes of electrode clamp force, and lower time to time variability can produce additional test samples. Further, an approach can be taken to rebalance the heat of the system. The bottom electrode resistance (R6) can be increased by changing the electrode material from tungsten copper to a more resistive tungsten alloy. The short duration pulse weld recipe with the higher resistivity bottom electrode can be the baseline resistance welding process for attaching SMA wire to stainless steel.

In an example embodiment, a method for performing a resistance welding process between a metal actuator and a shape memory alloy (SMA) wire is provided. The method can include positioning a resistance welder at a first end of the SMA wire and the metal actuator such that a top electrode is disposed adjacent to the SMA wire and a second electrode of the resistance welder is disposed adjacent to the metal actuator. An electrode material can include a tungsten alloy that includes an increased resistance compared to a resistance of more commonly used tungsten copper.

The method can also include performing, by the resistance welder, a first resistance weld at the first end of the SMA wire and the metal actuator by passing a current through the SMA wire and the metal actuator. The method can also include positioning the resistance welder at a second end of the SMA wire and the metal actuator such that the top electrode is disposed adjacent to the second end of the SMA wire and the second electrode of the resistance welder is disposed adjacent to the second end of the metal actuator. The method can also include performing, by the resistance welder, a second resistance weld at the second end of the SMA wire and the metal actuator by passing the current through the SMA wire and the metal actuator. Each of the first and second resistance welds can be performed for a weld pulse duration of around 9 milliseconds (ms).

In some instances, performing each of the first and second resistance welds include, between each weld pulse duration, a 2 ms ramp up and a 2 ms ramp down period, wherein a pulse current of each of the first and second resistance welds is around 110 amps. In some instances, the metal actuator comprises stainless steel.

In some instances, the resistance welder includes step sizes of power of around 0.001 watt-seconds (W-s), a pulse time step size of around. 1 ms and around 1 ms, step sizes of electrode clamp force of around 0.1 pounds (lbs), and lower time to time variability.

In some instances, the method can include obtaining a set of coupons of 0.004 inches thick comprising 302 stainless steel, performing a resistance weld on each of the coupons to SMA wires at weld strengths between about 25-35 grams with weld energies between about 2.2 to 4 watt-seconds for a pulse duration of around 10 ms, and testing one or more conditions of the set of coupons to determine weld peel strength of the coupons and wires attached to each of the coupons.

In some instances, testing the one or more conditions further includes performing, using a focused ion beam (FIB), a cross-section of welds on each of the coupons.

In some instances, the method can include performing a nanoindenting process to the SMA wire to measure a nanohardness and modulus on samples welded with different settings.

In some instances, the metal actuator is part of an optical image stabilization system.

Other features and advantages of embodiments of the present invention will be apparent from the accompanying drawings and from the detailed description that follows.

### BRIEF DESCRIPTION OF THE DRAWINGS

Embodiments of the present invention are illustrated, by way of example and not limitation, in the figures of the accompanying drawings, in which like references indicate similar elements and in which:

FIG. 1 illustrates that, in resistance welding, electrodes are used to provide the squeezing force and to deliver the electrical current to the work piece according to some embodiments.

FIG. 2 illustrates resistance welding SMA wire to buckler autofocus prototype according to some embodiments.

FIG. 3 illustrates an example process flow for assembling auto focus device prototype using SMA wire welding, such as a buckler type auto focus device according to some embodiments.

FIG. 4 illustrates that an actuator device, such as a bimorph type actuator device, can use a SMA wire that is resistance welded at both ends according to some embodiments.

FIG. 5 illustrates that a resistance welded joint connects the SMA wire to a stainless-steel substrate both electrically and mechanically according to some embodiments.

FIG. 6 illustrates example weld pull strength ranges from 91 to 99 grams and the failure mode in all cases is in the wire material according to some embodiments.

FIG. 7 illustrates example weld peel strength ranges from 20-26 grams and the failure mode in all cases is in the wire material according to some embodiments.

FIG. 8 illustrates a weld structure is evaluated by cross sectioning the weld using a FIB according to some embodiments.

FIGS. 9A-9F illustrate samples of FIB cuts of the welded interface of the SMA wire and stainless steel imaged with a SEM according to some embodiments.

FIG. 10 illustrates a resistance welder being installed and used for producing resistance welded test samples according to some embodiments.

FIG. 11 illustrates that no welds broke in life cycle tests according to some embodiments.

FIG. 12 illustrates a mechanical analysis of a sample of SMA wire welded to steel on both ends was tested and behaved more similarly to “as received” wire than wire that had been annealed red hot according to some embodiments.

FIG. 13 illustrate example pull test results show that a short duration weld pulse more closely matches the strength of “as received” SMA wire than samples made with a long duration pulse according to some embodiments.

FIG. 14 illustrates that SEM images show the grain structure of SMA wire can be very small, less than 100 nm according to some embodiments.

FIG. 15 illustrates that if the resistance at the interface of the electrode and work piece (R1) is too high, an unintended amount of heat is generated and the electrode sticks according to some embodiments.

FIG. 16 illustrates that many wire attach machines have automated functions for SMA wire delivery, and SMA wire crimping according to some embodiments.

FIG. 17 illustrates that the crimping die set (that currently closes and coins the wire crimps to attach the SMA wire) can be replaced with an electronically controlled, low force resistance weld head according to some embodiments.

FIG. 18 illustrates that the crimping die set (that currently closes and coins the wire crimps to attach the SMA wire) can be replaced with an electronically controlled, low force resistance weld head according to some embodiments.

FIG. 19 illustrates that the crimping die set (a) that currently closes and coins the wire crimps to attach the SMA wire, can be replaced with wire welding electrodes and wire cutting punch (b) according to some embodiments.

FIG. 20 illustrates that a precision stage carries a single electrode that welds both ends of the wire according to some embodiments.

FIG. 21 illustrates that a precision stage carries a single electrode that welds both ends of the wire according to some embodiments.

FIG. 22 illustrates that once the wire is welded to the work piece on both ends, a cut punch on a precision stage moves down and cuts the wire according to some embodiments.

FIGS. 23A-B illustrates (a) a scanning probe microscopy (SPM) image of a nanoindent of a cross section of an SMA wire weld, (b) Welded SMA wire with an area of cross section and nanoindent circled in white according to some embodiments.

FIG. 24 can illustrate Nanohardness, H of as received wire is 4.249 GPa and increases due to cold working when clamping the electrodes on the wire, but not applying any welding current according to some embodiments.

FIG. 25 illustrates that a Young's Modulus, E on as received wire is 67.711 GPa according to some embodiments.

FIG. 26 illustrates that material properties can be similar for low, nominal, and high weld energy, making wire welding tolerant of mass production levels of welder variation according to some embodiments.

FIG. 27A-C illustrate (a) SMA OIS platform development part used to test reliability of SMA wire welds; (b) SMA OIS platform development part with SMA wire welds; (c) SMA wire weld according to some embodiments.

FIG. 28 illustrates two OIS actuators are placed in a simulated smartphone handset and dropped from a height of 1.6 m onto a concrete floor according to some embodiments.

FIGS. 29A-H illustrate that SMA wire welds on OIS platform development parts pass drop test according to some embodiments.

FIGS. 30A-D illustrate that SMA wire welding including (a) lens shift optical image stabilization (OIS) system, such as a bimorph type lens shift OIS (b) an auto focus (AF) system, such as a buckler type AF, (c) OIS long wire platform development, and (d) sensor shift OIS system, such as a bimorph type sensor shift OIS, according to some embodiments.

FIGS. 31A-B illustrate top electrode dimensions as tested according to some embodiments.

FIG. 32 illustrate bottom electrode dimensions as tested according to some embodiments.

FIG. 33 illustrates example electrodes with 1500 weld cycles in static location burn in depth according to some embodiments.

FIGS. 34A-D illustrate example static welds according to some embodiments.

FIGS. 35A-B illustrate examples for 1000 cycles according to some embodiments.

FIGS. 36A-C illustrate examples for 1500 cycles according to some embodiments.

FIG. 37 illustrates example stepped welding with 4 um deviation across electrode surface at 1000 cycles according to some embodiments.

FIGS. 38A-C illustrate example stepped welding from 1-1000 cycles according to some embodiments.

FIGS. 39A-C illustrates example stepped welding measurements according to some embodiments.

FIG. 40 illustrates an example set of weld positions as part of a resistance welding technique according to some embodiments.

FIG. 41 illustrates an example set of weld positions capable of being rotated according to some embodiments.

### DETAILED DESCRIPTION

A shape memory alloy (SMA) can include an element (e.g., a wire) configured to actuate when provided a current. Such actuation can be used to move an object, such as a moving carriage or lens in an autofocus (AF) or optical image stabilization (OIS) system in an imaging device. The SMA element can be an alloy of nickel and titanium (commonly called nitinol).

The SMA element can be joined to the actuator (e.g., made of stainless steel) using a resistance welding process that includes joining two metals by passing current through them electronically and mechanically. The SMA wire and stainless steel can be squeezed between opposing electrodes and current is delivered through the electrodes to create joule heating.

A modern resistance welder, with smaller step sizes of power, lower total power, smaller step sizes of electrode clamp force, and lower time to time variability can be used to produce test samples. Further, a baseline weld recipe is established by building coupons made of 0.004″ thick 302 stainless steel at different weld energies and peel testing them. Weld strength plateaus at 25 to 35 grams with weld energies (technically weld work in units of wattseconds) ranging from 2.2 to 4 watt-seconds for a pulse duration of 10 ms. A baseline setting of 2.4 watt-seconds can be selected.

A weld structure can be evaluated by cross sectioning a weld using a focused ion beam (FIB) and examining the two materials being welded with a SEM. Functional tests can be conducted by running coupon parts through life cycle testing. The goal for welding SMA wire can be to affect the wire material as little as possible while still making a strong mechanical connection.

A dynamic mechanical analysis can be done to measure the effect of heat on the mechanical properties of SMA wire. Two samples can be compared, 1) as received SMA wire, and 2) SMA wire that has been annealed by running electrical current through it so that it glowed red for about 1 second.

A pull strength of welded wire can be compared to “as received” SMA wire (i.e., SMA wire—directly from the wire spool as shipped from the supplier—that has not been welded). Two conditions can be compared, SMA wire welded to a 30 μm thick 302/304 stainless steel substrate with a 1) short duration pulse, and with a 2) long duration pulse. Images scanning electron microscopy (SEM) of the SMA material in an unaffected area and a weld affected area can be compared.

A novel approach can be taken to rebalance the heat of the system. The bottom electrode resistance (R6) can be increased by changing the electrode material from tungsten copper to a more resistive tungsten alloy. This can improve the balance in heat generation at the two electrode interfaces and resolved the sticking problem at the top electrode. For instance, a tungsten alloy can be used. The short duration pulse weld recipe (from table 3) with the higher resistivity bottom electrode can be the baseline resistance welding process for attaching SMA wire to stainless steel.

In many instances, the SMA can be challenging to weld with high reliability and good performance. Nitinol that is fusion welded to stainless steel can be inherently weak due to brittle inter-metallics at the interface of the nitinol and stainless-steel substrate. The weld energy can also affect the shape memory character of the nitinol leading to performance loss. A solid-state weld formed by resistance welding, which can have minimal to no inter-metallics, and can create atomic bonds at lower temperatures than fusion welding, can be studied to see if it overcomes the risks of inter-metallics and loss of shape memory character.

The particular shape memory alloy (SMA) used in Buckle, Bimorph, or other SMA actuators can include NITINOL, which derives its name from an alloy of nickel and titanium. SMA can generally have the property of shrinking when heated. For a buckler-type actuator, electrical current can be routed through the SMA wire. Due to the electrical resistance of the SMA wire, joule heating proportional to the amount of current can occur. The wire can reach its phase transformation temperature and can transition from its martensitic phase to its austenitic phase, which can result in a strain in the wire.

The SMA wire can be fixed to a mechanism made partially or fully of stainless-steel members by resistance welding the SMA wire to the stainless steel. Resistance welding can produce compelling results in early development, where a small quantity of prototype actuators built with resistance welding have shown good performance and reliability. Previous generation actuators used crimping to connect the wire to the actuator mechanism.

Crimps can use material to be formed and coined around the wire to make a low resistance electrical connection as well as a high retention mechanical connection. The crimping process can be less than desirable because it has a very small process window. Coining too much can result in an electrical short if the insulating layers of the crimp are collapsed against the wire. If the crimp is not coined enough, the mechanical connection can have low retention and the wire may come loose under load. Nitinol can be welded to steel in some medical device applications, like guidewires, but there is generally not broad industry knowledge of how to do this. Therefore, development with empirical testing was needed to truly understand the limits and the reliability of SMA wire welding.

Shape memory alloy (SMA) wire has the property of “shape memory” so that when SMA is heated, it shrinks, making SMA a useful “engine” for actuators including optical image stabilizer (OIS) and auto focus (AF) actuators used in smartphone cameras among other potential uses. Previous SMA applications used the method of crimping to attach the SMA wire to the actuator. There is opportunity to miniaturize the design and reduce the number of assembly process steps for an actuator by welding the SMA wire to the actuator.

The roadmap of future OIS and AF actuators use SMA wire welding to attach the SMA wire and replace the crimping method of attaching wires. Resistance welding is being pursued because it may enable a larger process window than the current method of crimping the wire to attach it. Resistance welding also provides design flexibility in where the wire can be attached to a mechanism and how much space is dedicated to making the connection to the SMA wire.

There is opportunity to miniaturize smartphone camera shape memory alloy (SMA) actuator designs and reduce the number of assembly process steps for an actuator by welding the SMA wire to the actuator. Resistance welding can include the process of joining two metals by passing current through them to create joule heating so that the two materials bond together. The resistance welded joint connects the SMA wire to a stainless-steel substrate both electrically and mechanically.

A baseline recipe was developed for welding SMA wire to stainless steel and welds made with this recipe prove to be strong and reliable. Actuators with welded SMA wire achieve 1 million cycles without failure and pass drop shock tests. Nanoindent testing shows that material properties are similar for low, nominal, and high weld energy, making wire welding tolerant of mass production levels of welder variation.

A heat generation equation 1 can include Q=I\hat{ }2Rt, where Q is heat generation, I is resistance welding electrical current, R is total resistance, and t is welding time. This equation can be a governing equation for heat generation in resistance welding.

Resistance welding is the process of joining two metals by passing current through them to create joule heating so that the two materials bond together. The bond formed by resistance welding can be a fusion bond, where the two materials have both reached their melting point and intermixed, or a solid-state bond, where there is little to no fusion, but there is inter-diffusion of the atoms of the two joining surfaces.

Electrodes can be used to provide the squeezing force and to deliver the electrical current to the work piece. The weld begins to form at the high resistance interface of the two metals. As that interface collapses, heat continues to transfer outward toward the electrodes until the electrical current flow is halted by the resistance welder controller.

As shown in Equation 1, some of the key factors in resistance welding are the heat generated due to the resistivity of the two metals being joined; the amplitude of electrical current flowing through the work pieces; the time duration the current flow remains on; and the amount of force pressing the work pieces together by the electrodes. It can be common for resistance weld systems to have spring loaded electrodes so that the electrode can “follow” the work piece if it becomes thinner during the welding process.

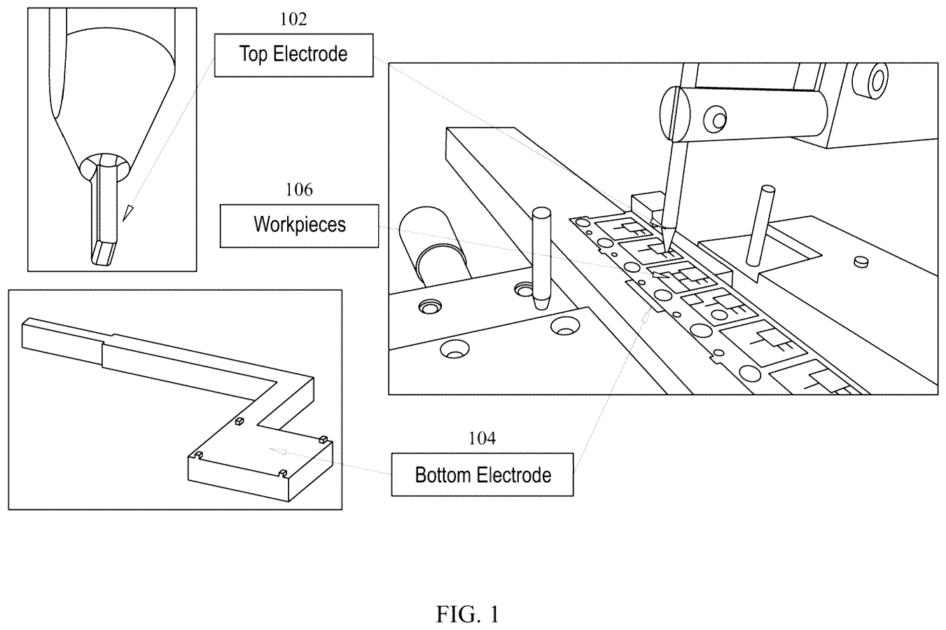

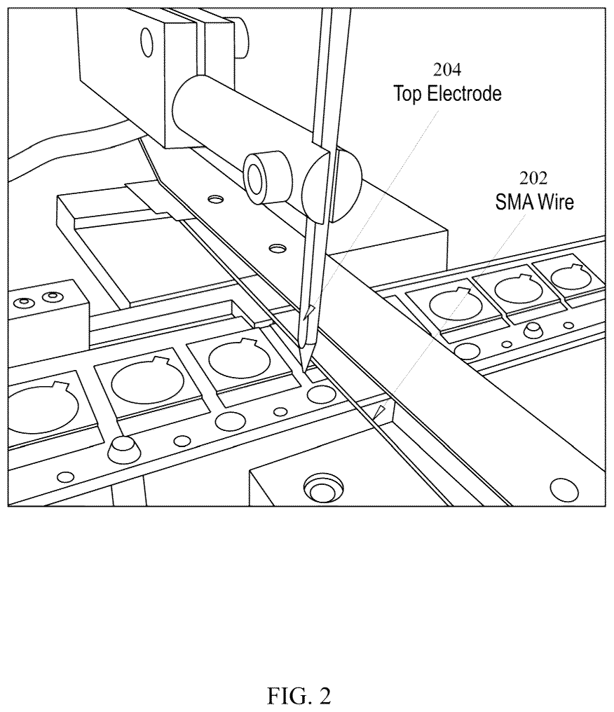

FIG. 1 illustrates that, in resistance welding, top 102 and bottom 104 electrodes are used to provide the squeezing force and to deliver electrical current to work piece(s) 106. Further, FIG. 2 illustrates resistance welding SMA wire 202 with a top electrode 204 to autofocus prototype.

In some instances, a static electrode method indicates maximum of approx. 1000 weld cycles before electrode reconditioning can be required. Manually stepping wire across electrode indicates potential for significantly increasing weld cycles before reconditioning is required. The present embodiments can also relate to an automated electrode stepping method to enable high-volume manufacturing.

In such examples, the present embodiments can include small incremental rotational movement of the electrodes as well as small incremental translational movement of the electrodes. The small incremental rotational movement of the electrodes could be a feasible approach for a round electrode tip application. Translational movement of the electrodes can dramatically improve wear performance and cycles between electrode resurfacing. Further, a challenge with joining dissimilar materials such as SMA wire and stainless steel using a resistance weld application can be arriving at the proper heat balance of both materials to achieve a solid-state bond. Using the top and bottom electrode geometries along with the proper weld recipe and an electrode material with the correct resistance, hardness and high temperature capabilities, can result in an optimal solid-state bond. A solid-state bond can be achieved when the weld interface temperature reaches approximately 80% of the melt point of both materials during the weld cycle. At this temperature, there is little to no fusion but there can be inter-diffusion of the atoms of the two joining materials. An annealed tungsten electrode material can be used, which can be a significant improvement in other resistance welding processes.

After switching to a Tungsten electrode material for the top and bottom electrode, a “part to electrode” sticking problem can be reduced and premature electrode cracking can be mitigated. Reducing electrode wear further is where the translational “micro move” idea originated. The electrode can be a: ANSI/AWS A5.12, DIN EN ISO 6848, JIS Z 3233 standard with a split-free/annealed, Eddy current tested.

### Designs

The resistance welded joint being used can connect the SMA wire to a stainless-steel substrate both electrically and mechanically. The buckler autofocus prototype and the bimorph actuator prototype both use SMA wire that is resistance welded. SMA wire and stainless steel can be squeezed between opposing electrodes and current is delivered through the electrodes to create joule heating. The heating can bring the temperature of the steel and the SMA near their melting points and the pressure causes them to bond together. To date, it is typical for the wire to be flattened and widened by the pressure of the electrode.

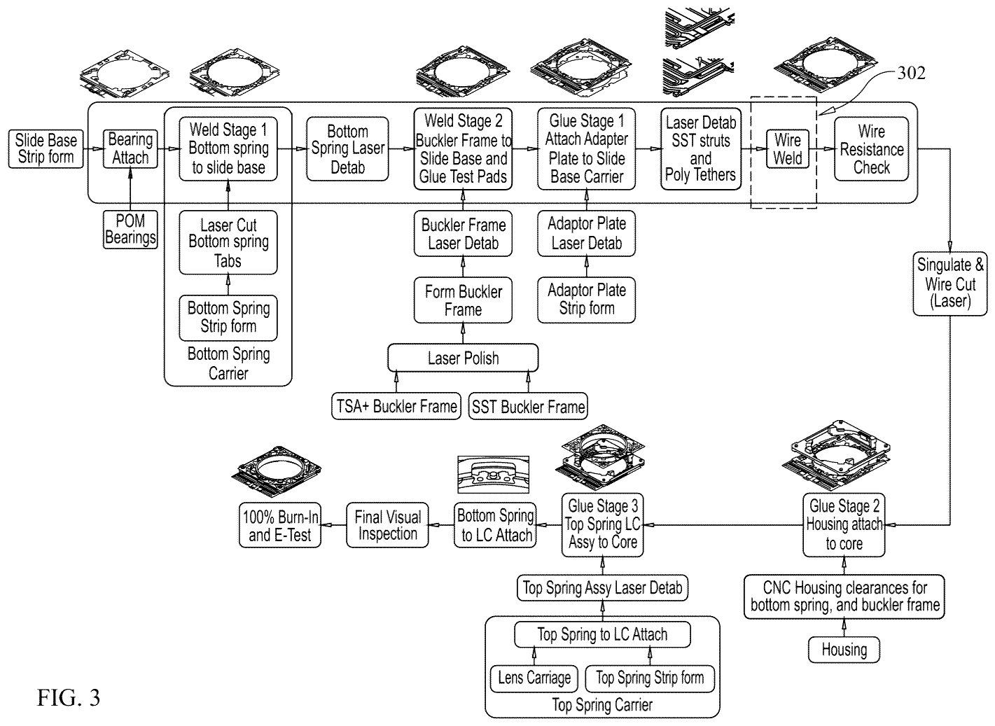

FIG. 3 illustrates an example process flow for assembling auto focus prototype, such as a buckler type auto focus prototype, using SMA wire welding. As shown in FIG. 3, a wire weld step 302 can be incorporated after a laser detab step and prior to a wire resistance weld check. In some embodiments the wire weld step 302 may be carried out by performing a resistance welding process between a metal actuator and a shape memory alloy (SMA) wire, wherein a resistance welder is positioned at a first end of the SMA wire and the metal actuator such that a top electrode is disposed adjacent to the SMA wire and a second electrode of the resistance welder is disposed adjacent to the metal actuator, wherein an electrode material is a tungsten alloy that includes an increased resistance to a resistance of tungsten copper; the resistance welder performs a first resistance weld at the first end of the SMA wire and the metal actuator by passing a current through the SMA wire and the metal actuator; the resistance welder is positioned at a second end of the SMA wire and the metal actuator such that the top electrode is disposed adjacent to the second end of the SMA wire and the second electrode of the resistance welder is disposed adjacent to the second end of the metal actuator; and the resistance welder performs a second resistance weld at the second end of the SMA wire and the metal actuator by passing the current through the SMA wire and the metal actuator, wherein each of the first and second resistance welds are performed for a weld pulse duration of around 9 milliseconds (ms).

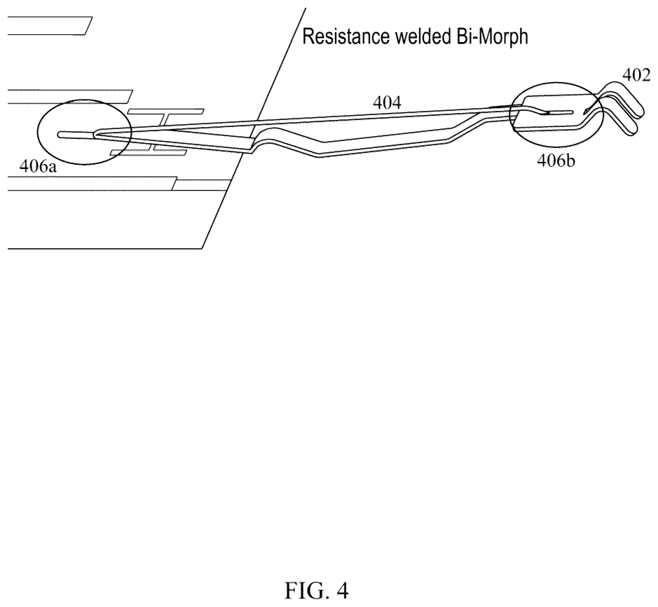

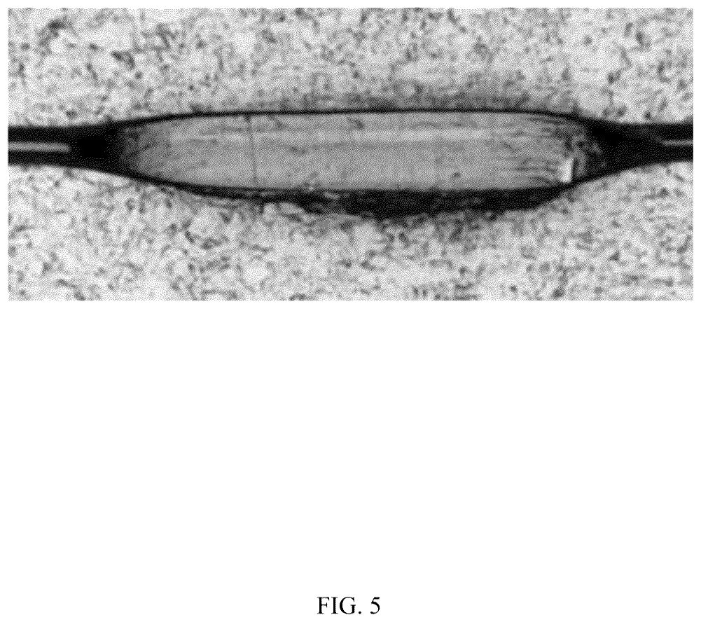

FIG. 4 illustrates that a bimorph actuator prototype 402 can use a SMA wire 404 that is resistance welded at both ends 406a, 406b. FIG. 5 is a photograph illustrating that a resistance welded joint connects the SMA wire to a stainless-steel substrate both electrically and mechanically. It can be typical for the wire to be flattened and widened by the pressure of the electrode.

Another welder design being used for testing can have limited capability. The step size of adjustments is coarse and the minimum power for welding is high for 25 μm to 30 μm diameter SMA wire. A resistance welder, with smaller step sizes of power, lower total power, smaller step sizes of electrode clamp force, and lower time to time variability is being purchased and will be used to produce additional test samples.

### Testing

Weld strength and quality are evaluated several ways. Pull tests are used to test the shear strength of the weld. Peel tests peel the wire from the steel and are another metric of strength. Pull tests and peel tests are run until sample failure and the failure modes for both tests are recorded. Typical welding failure modes in weld strength tests are fractures at the interface of the two pieces being welded (weld break), or fracture of the material being welded (the latter indicating the weld is stronger than the material being joined).

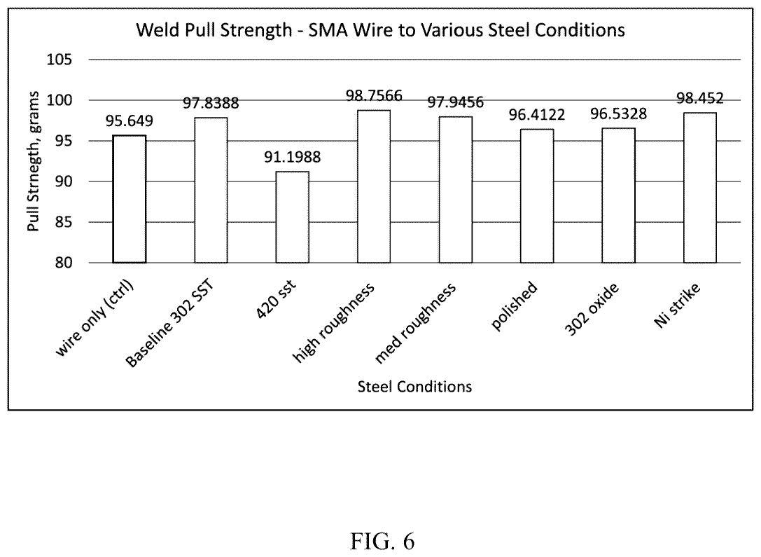

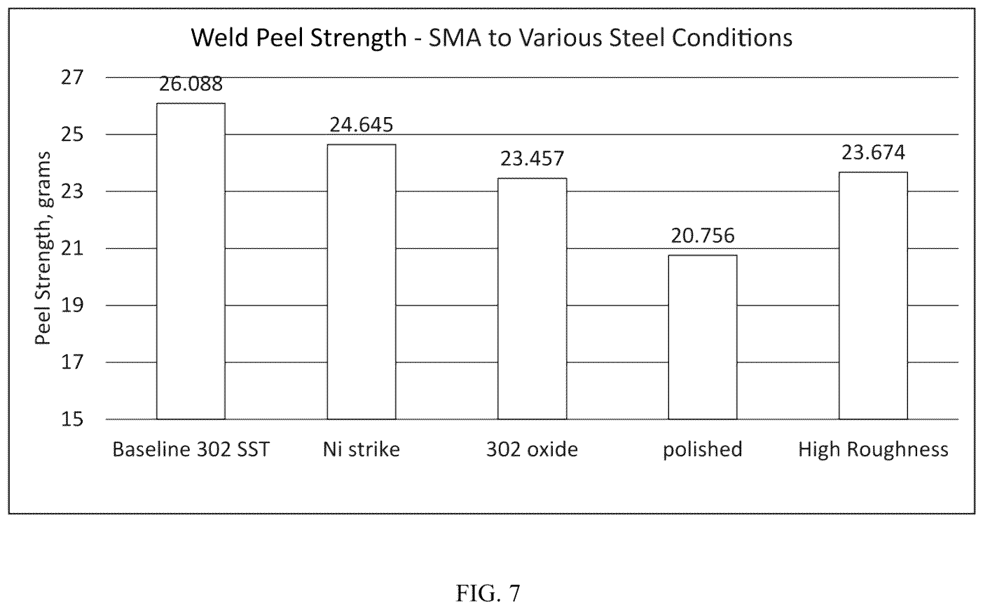

FIG. 6 illustrates a graph with example weld pull strength ranges from 91 to 99 grams and the failure mode in all cases is in the wire material. FIG. 7 illustrates a graph with example weld peel strength ranges from 20-26 grams and the failure mode in all cases is in the wire material.

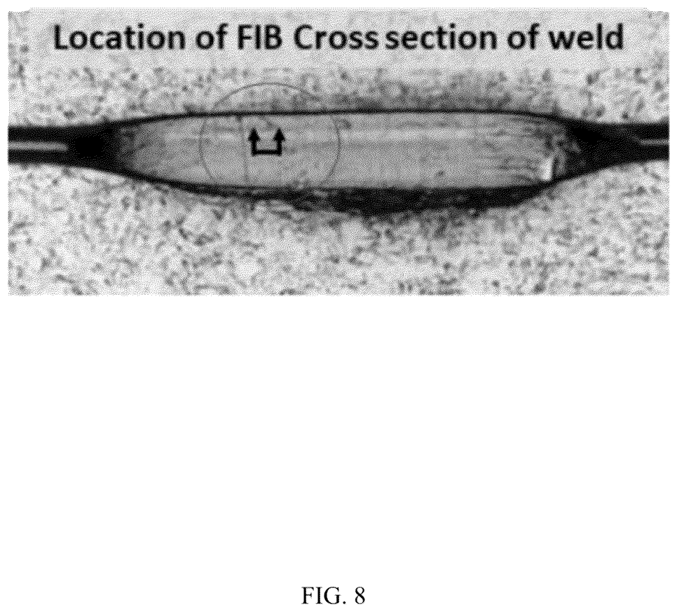

To understand if the steel condition effects the weld quality, several conditions of steel are tested including the baseline 302 stainless steel material. Functional tests are conducted by running coupon parts through life cycle testing. Weld structure is evaluated by cutting a cross section of the weld using a Focused Ion Beam (FIB) as shown in FIG. 8 and examining the two materials being welded with a scanning electron microscope. Several conditions of SMA wire and stainless steel are examined to understand if a condition promotes or inhibits bonding of the materials.

### Results

A baseline weld process can be established by building coupons made of 0.004″ thick 302 stainless steel at different weld energies and peel testing them. Weld strength plateaus at 25 to 35 grams with weld energies (technically weld work in units of watt-seconds) ranging from 2.2 to 4 watt-seconds for a pulse duration of 10 ms. A baseline setting of 2.4 watt-seconds can be selected.

Several conditions of steel can be tested with the baseline setting of 2.4 watt-seconds including the baseline 302 stainless steel material. Weld pull strength ranges from 91 to 99 grams and the failure mode in all cases is in the wire material, which breaks at the edge of the weld. Weld peel strength ranges from 20-26 grams and the failure mode in all cases is in the wire material, which breaks at the edge of the weld. In both strength tests, the failure mode is in the SMA wire which means the condition of the steel surface is not a factor in these results. The pull strength and peel strength can be based on the strength and condition of the SMA wire at the edge of the weld.

Weld strength testing can include samples where there are failure modes in the weld, but in all cases the failure mode was SMA wire breaks. It is apparent that the weld strength, which is a function of weld energy, could be reduced. A resistance welder, with smaller step sizes of power, lower total power, smaller step sizes of electrode clamp force, and lower time to time variability is being purchased and can be used to produce additional test samples.

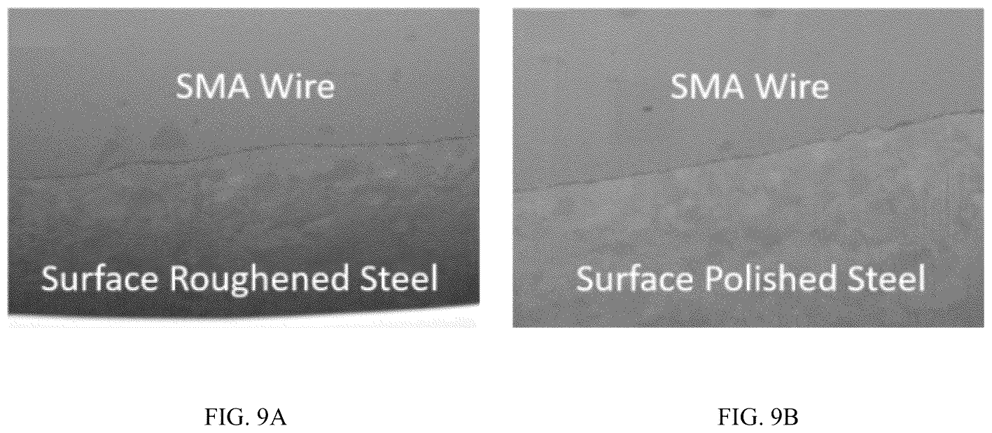

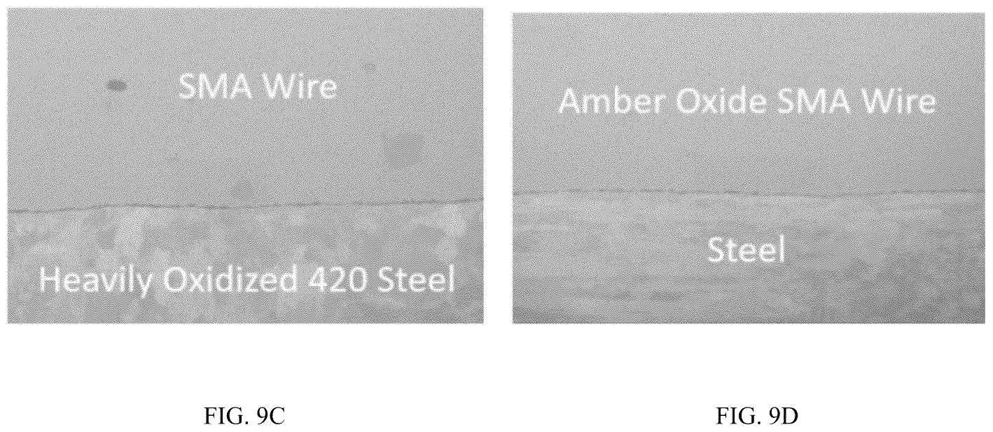

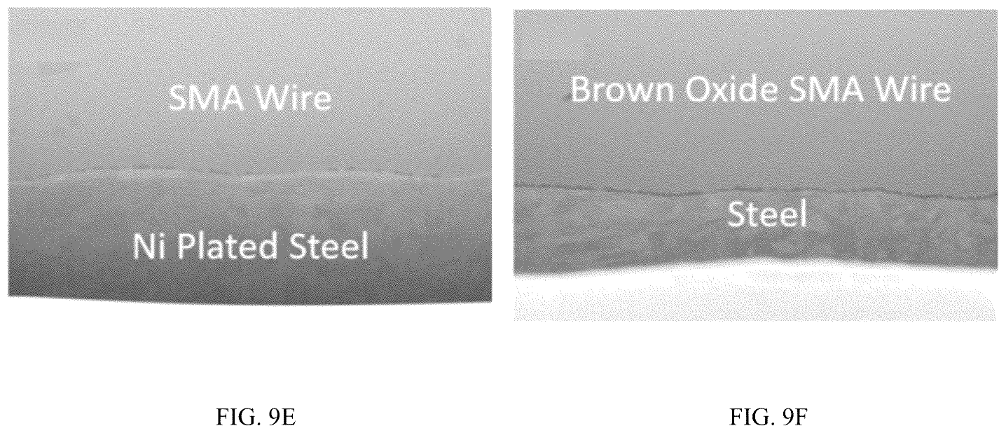

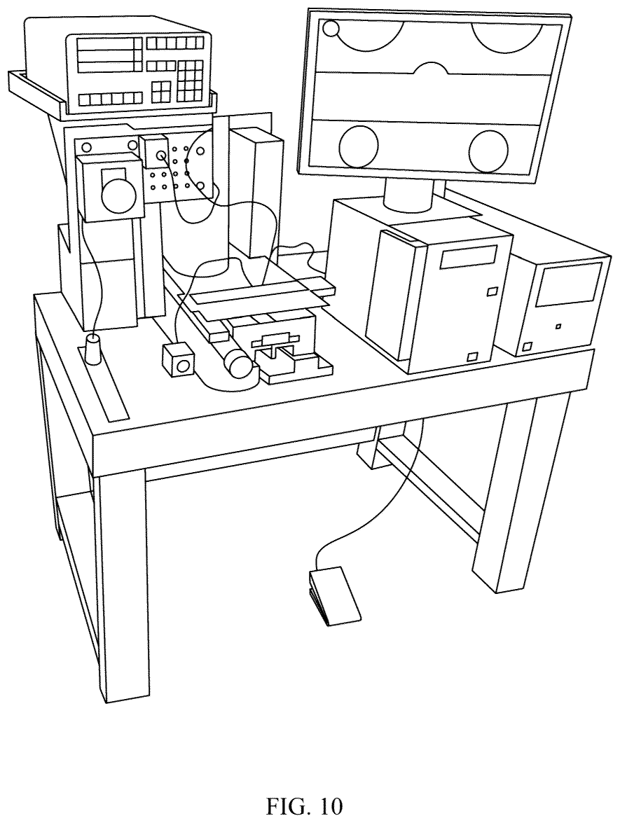

Weld structure can be evaluated by cross sectioning a weld using a FIB and examining the two materials being welded with a SEM. Samples of FIB cuts of the welded interface of the SMA wire and stainless steel are shown in FIGS. 9A-9D. Roughening or polishing the surface (FIGS. 9a and 9b respectively) have no effect on the weld interface. Oxide on the steel or SMA wire (FIGS. 9c, 9d, and 9f) did not inhibit welding. Nickel plating the steel (FIG. 9e) might be expected to increase fusion between with the nickel in SMA wire, but all cases there is no fusion of the materials present in the images, regardless of material condition. Based on the high strength of the welds (the wire breaks in peel tests, not the weld), there can be diffusion and bonding at the atomic level which results in strong solid-state welds.

A resistance welder can be installed and used for producing resistance welded test samples. The welder can be a resistance welder with smaller step sizes of power, lower total power, smaller step sizes of electrode clamp force, and lower time to time variability than the welder it replaces. An encoder readout and manually operated stage can be added to improve weld placement consistency.

Functional tests can be conducted by running coupon parts through life cycle testing. Results show that no welds broke in life cycle tests. Half of the parts tested survived one million cycles and were stopped. Half of parts suffered infant mortality (failed at less than 20,000 cycles) related to the stress load in the wire (stress load related failures are out of scope of the SMA wire welding project and being addressed by separate project).

FIG. 8 illustrates a weld structure evaluated by cross sectioning the weld using a FIB.

FIGS. 9A-F illustrates samples of FIB cuts of the welded interface of the SMA wire and stainless steel imaged with a SEM. In all cases there is no fusion of the materials present in the images. Based on the high strength of the welds (the wire breaks in peel tests, not the weld), there is diffusion and bonding at the atomic level which results in strong solid-state welds.

FIG. 9A illustrates roughening or polishing the surface (FIGS. 9a and 9b respectively) can have no effect on the weld interface. Further, FIG. 9C illustrates oxide on the steel or SMA wire (FIGS. 9c, 9d, and 9f) did not inhibit welding.

The goal for welding SMA wire can be to affect the wire material as little as possible while still making a strong mechanical connection. A dynamic mechanical analysis can be done to measure the effect of heat on the mechanical properties of SMA wire. Two samples can be compared, 1) as received SMA wire, and 2) SMA wire that has been annealed by running electrical current through it so that it glowed red for about 1 second. It is reasonable to assume that resistance welded wire would have material properties that lie between these two samples. Mechanical analysis of a sample of SMA wire welded to steel coupons on both ends was tested and behaved more similarly to “as received” wire than wire that had been annealed red hot.

FIG. 10 illustrates a resistance welder being installed and used for producing resistance welded test samples.

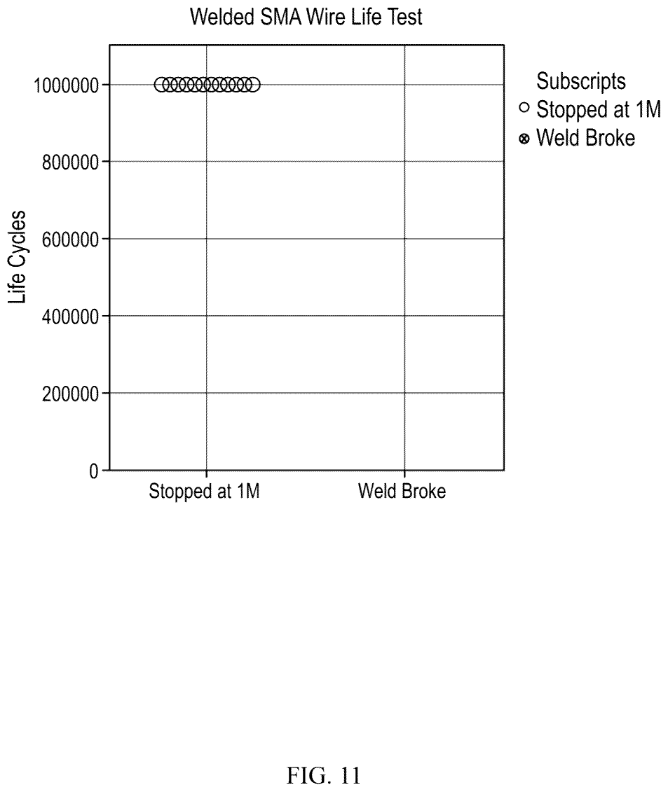

FIG. 11 is an example chart showing that no welds broke in life cycle tests. Parts tested survived one million cycles and were stopped.

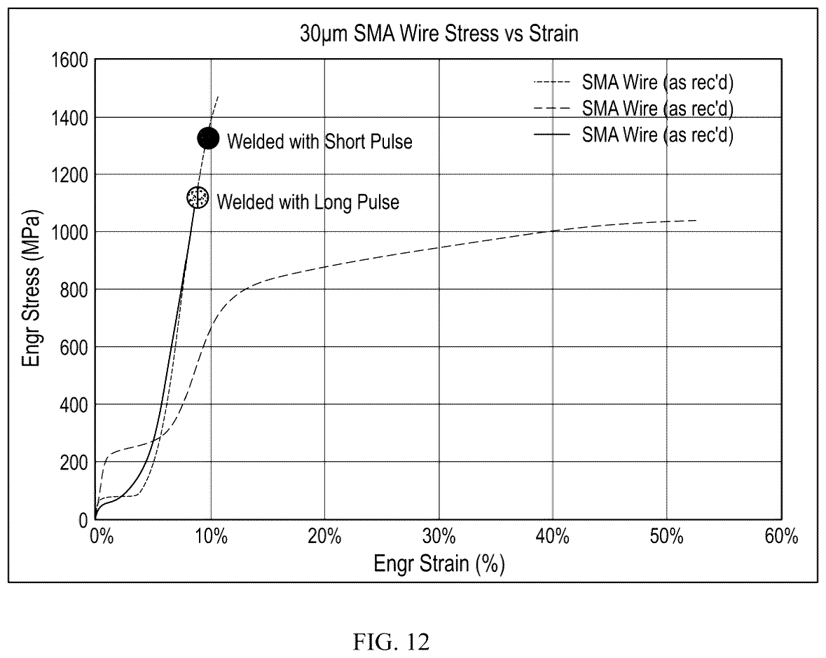

FIG. 12 is an example chart illustrating mechanical analysis of a sample of SMA wire welded to steel on both ends was tested and behaved more similarly to “as received” wire than wire that had been annealed red hot. Average pull strength of samples welded with short pulse and long pulse can be superimposed on the stress strain graph for reference.

Pull strength of welded wire can be compared to “as received” SMA wire (i.e., SMA wire—directly from the wire spool as shipped from the supplier—that has not been welded). Two conditions are compared, SMA wire welded to a 30 μm thick 302/304 stainless steel substrate with a 1) short duration pulse, and with a 2) long duration pulse. Pull test results show that a short duration weld pulse (average pull strength of 1,323 MPa) more closely matches the strength of the “as received” SMA wire (1,463 MPa) than samples made with a long duration pulse (average pull strength of 1,148 MPa). Long pulse may affect the metallurgy of the SMA wire more than short pulse since the pull strength is lower.

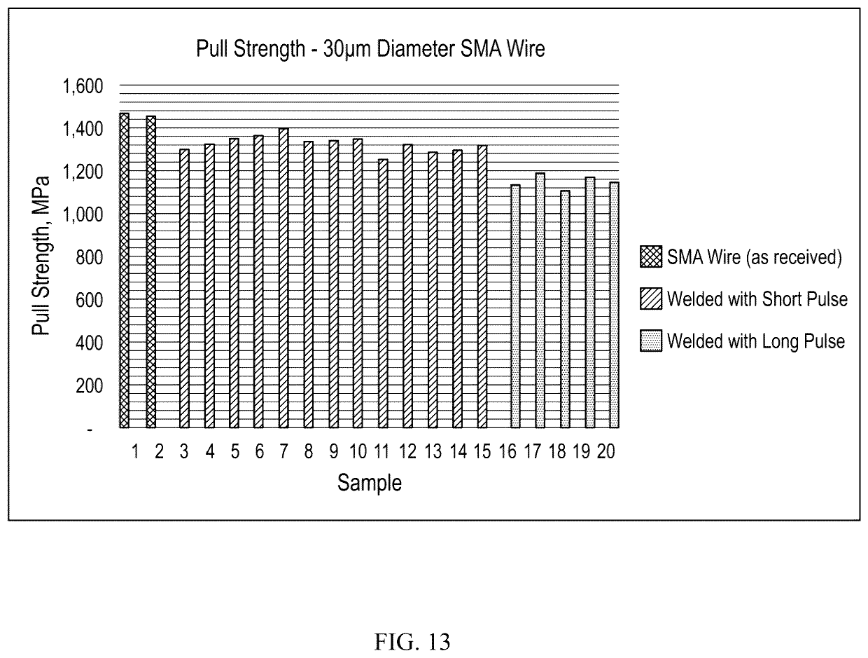

FIG. 13 is an example graph illustrating example pull test results which show that a short duration weld pulse more closely matches the strength of “as received” SMA wire than samples made with a long duration pulse. Long pulse can affect the metallurgy of the SMA wire more than short pulse since the pull strength of long pulse is lower.

Images scanning electron microscopy (SEM) of the SMA material in an unaffected area and a weld affected area can be compared. The analysis attempts to compare the grain structure to better understand the effect of resistance welding on the SMA wire. A focused ion beam (FIB) is used to cut away material to show a cross section of the SMA wire. The SEM images show the grain structure of SMA wire is very small, less than 100 nm. Images of wire (both in unaffected areas and areas affected by welding) at 30 k× magnification are not able to discern the grain boundaries of the SMA material. No conclusion of similarity or difference between unaffected wire and wire affected by resistance welding can be made from these SEM images.

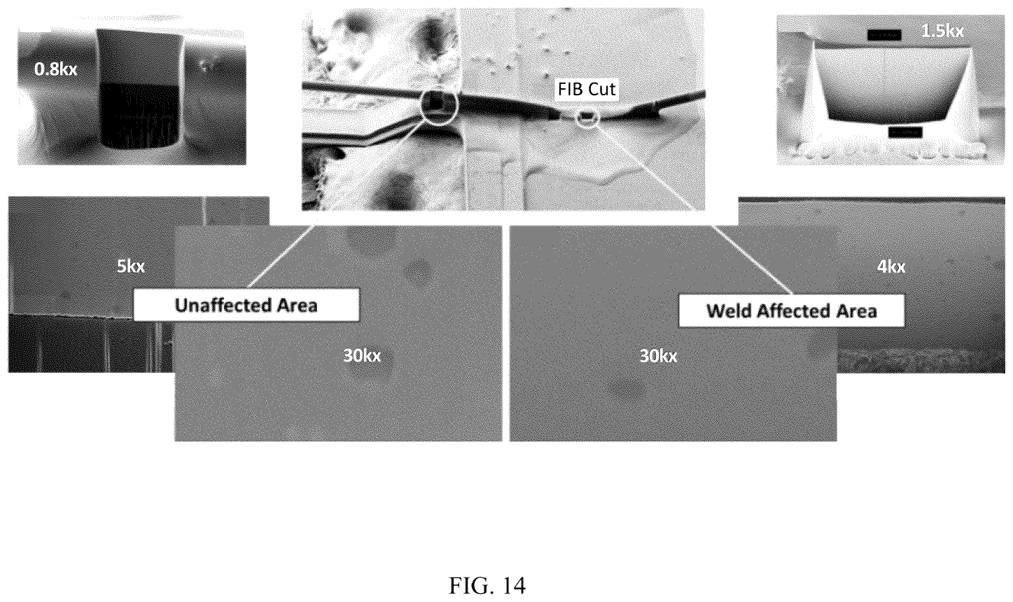

FIG. 14 illustrates that SEM images show the grain structure of SMA wire can be very small, less than 100 nm. Images of wire, both in unaffected areas and areas affected by welding, and at 30 k× magnification are not able to discern the grain boundaries of the SMA material.

During the course of development, electrode sticking can become a prominent problem. Freshly dressed top electrodes would begin to stick to the SMA wire within the first or second hit. The SMA wire can be welded to a thin foil of stainless steel, only 30 μm thick, so when the SMA wire is separated from a stuck electrode, the part gets bent and damaged.

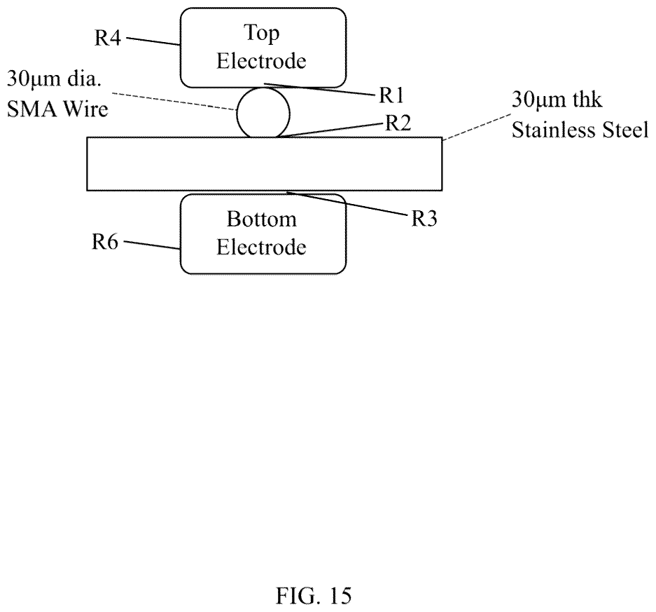

From equation 1, heat generation in resistance welding can be proportional to resistance of the electrical path through the electrodes and work pieces. Refer to FIG. 15. If the resistance at the interface of the electrode and work piece (R1) is too high, an unintended amount of heat is generated and the electrode sticks.

Heat balance can be an important consideration. The top electrode can be made smaller over time through repeated electrode resurfacing and shaping. This can make resistance (R4 and R1) higher through the top electrode and between the top electrode and the work piece, which increased the heat in that area, resulting in stuck electrodes.

This approach can have been taken to rebalance the heat of the system. The bottom electrode resistance (R6) was increased by changing the electrode material from tungsten copper to a more resistive tungsten alloy. This improved the balance in heat generation at the two electrode interfaces and resolved the sticking problem at the top electrode.

FIG. 15 illustrates that if the resistance at the interface of the electrode (R4) and work piece (R1) is too high, an unintended amount of heat is generated and the electrode sticks. This can improve the balance in heat generation at the two electrode interfaces and resolved the sticking problem at the top electrode (R4). In some instances, various specifications for tungsten and oxide dispersed tungsten electrodes for arc welding and cutting can be used.

The short duration pulse weld recipe with the higher resistivity bottom electrode can be the baseline resistance welding process for attaching SMA wire to stainless steel.

Many wire attach machines have automated functions for part handling, SMA wire delivery, and SMA wire crimping. In one initial concept, many part handling and SMA wire delivery functions in the wire attach machine are preserved. The crimping die set (that currently closes and coins the wire crimps to attach the SMA wire) can be replaced with an electronically controlled, low force, resistance weld head with top and bottom electrodes. Work continues on resistance welding integration concepts.

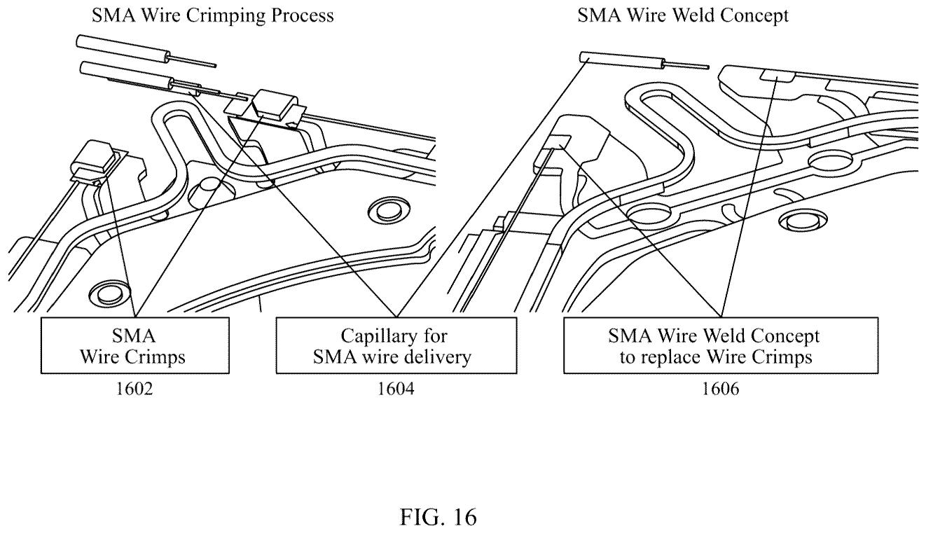

FIG. 16 illustrates that many wire attach machines have automated functions for SMA wire delivery, and SMA wire crimping. The crimping die set can be replaced with a resistance weld head. As shown in FIG. 16, an SMA wire crimping process can include SMA wire crimps 1602. Further, the SMA wire crimping process or the SMA wire weld process can include a capillary for SMA wire delivery 1604 and a SMA wire weld concept to replace wire crimps 1606.

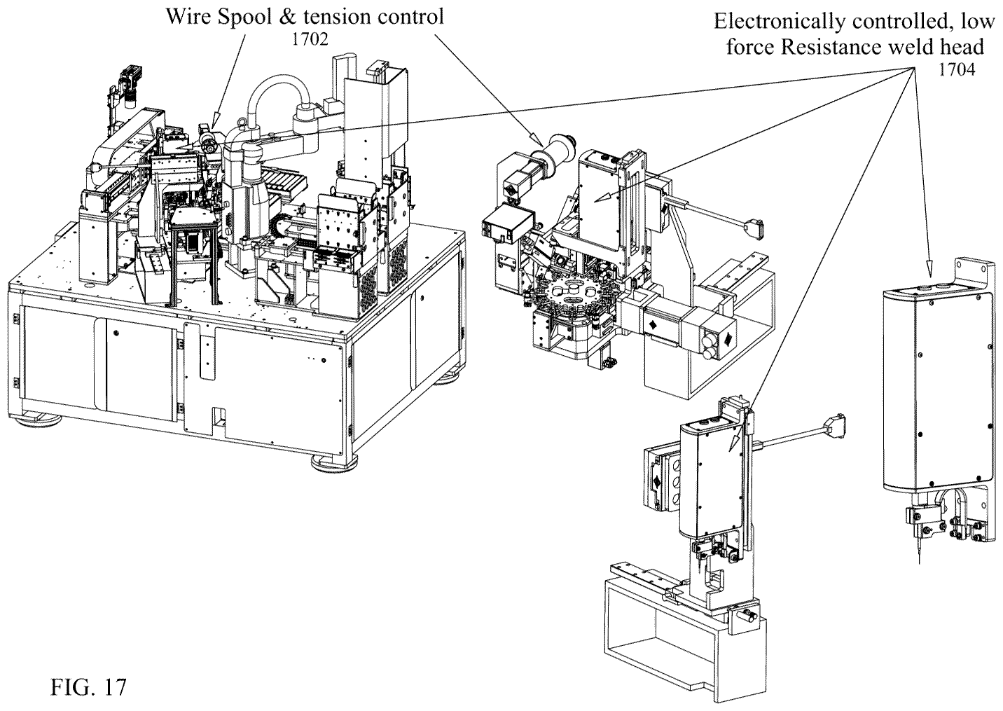

FIG. 17 illustrates that the crimping die set (that currently closes and coins the wire crimps to attach the SMA wire) can be replaced with an electronically controlled, low force resistance weld head. In FIG. 17, a wire spool and tension control component 1702 and an electronically controlled, low force resistance weld head 1704 can be incorporated in the systems as described herein.

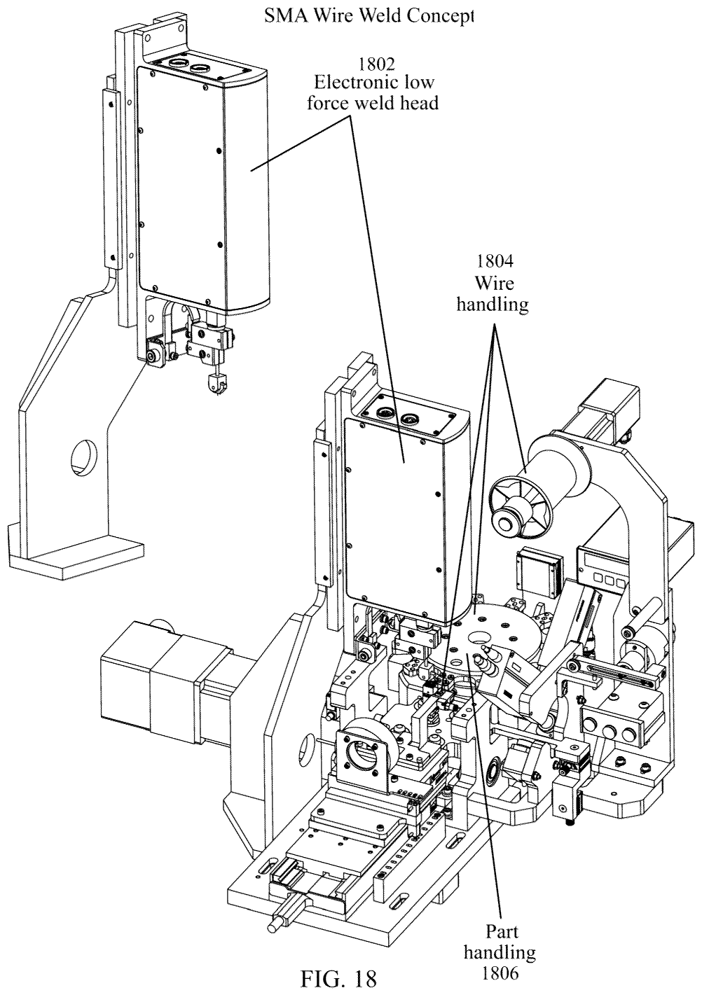

FIG. 18 illustrates that the crimping die set (that currently closes and coins the wire crimps to attach the SMA wire) can be replaced with an electronically controlled, low force resistance weld head. As shown in FIG. 18, a SMA wire weld concept can include an electronic low force weld head 1802, wire handling components 1804, and part handling components 1806.

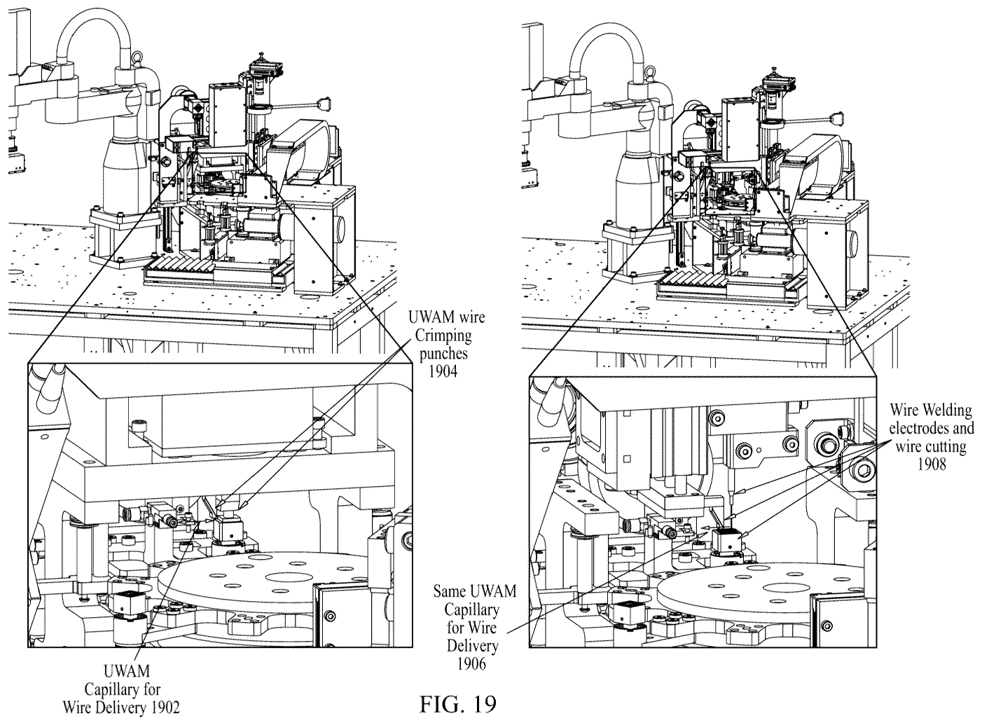

FIG. 19 illustrates that the crimping die set that currently closes and coins the wire crimps to attach the SMA wire, can be replaced with wire welding electrodes and wire cutting punch. The same wire attach machine capillary for wire delivery can be retained. As shown in FIG. 19, a ultrasonic welding additive manufacturing (UWAM) capillary for wire delivery 1902 and UWAM wire crimping punches 1904 can be used in the systems as described herein. Further, a UWAM capillary for wire delivery 1906 and wire welding electrodes and wire cutting components 1908 can be used in such systems.

A precision stage carries a single electrode that welds both ends of the wire. By moving from the first position to the second position, the need for a second weld head can be eliminated. Once the wire is welded to the work piece on both ends, a cut punch on a precision stage moves down and cuts the wire. The rotary stage from the original machine design is retained and rotates the work piece a quarter turn and the cycle of welding and cutting the SMA wire repeats. After all four sides of the work piece have wires attached with resistance welding, many part handling automation can exchange out the finished part with the next part to be processed.

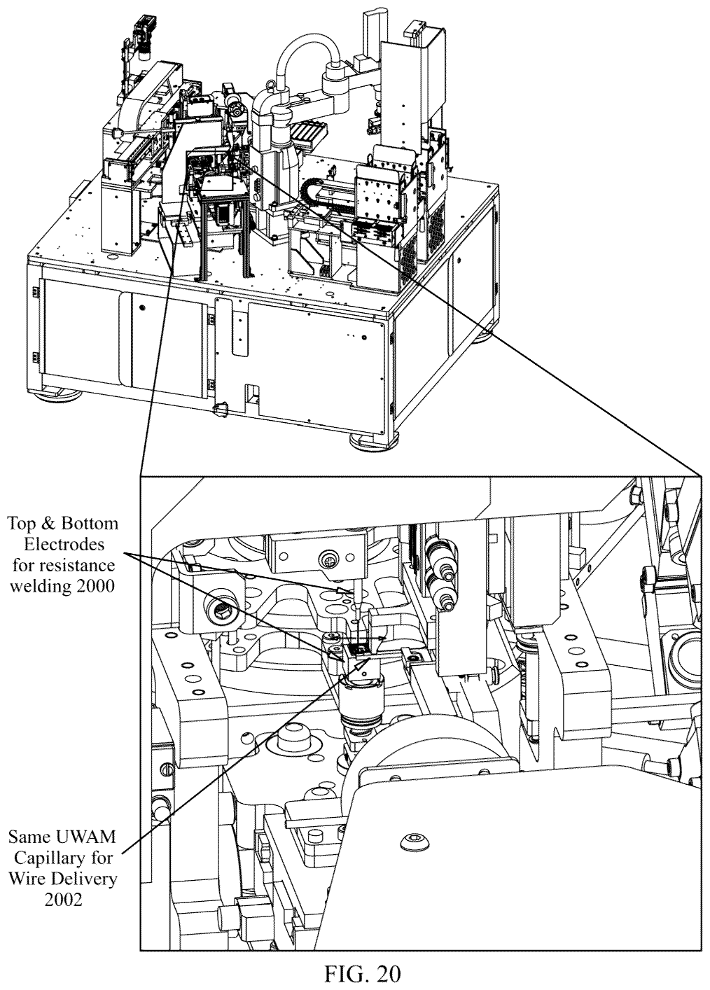

FIG. 20 illustrates that a precision stage carries a single electrode that welds both ends of the wire. By moving from the first position to the second position, the need for a second weld head is eliminated. In FIG. 20, top and bottom electrodes for resistance welding 2000 and a UWAM capillary for wire delivery 2002 can be used in the present systems.

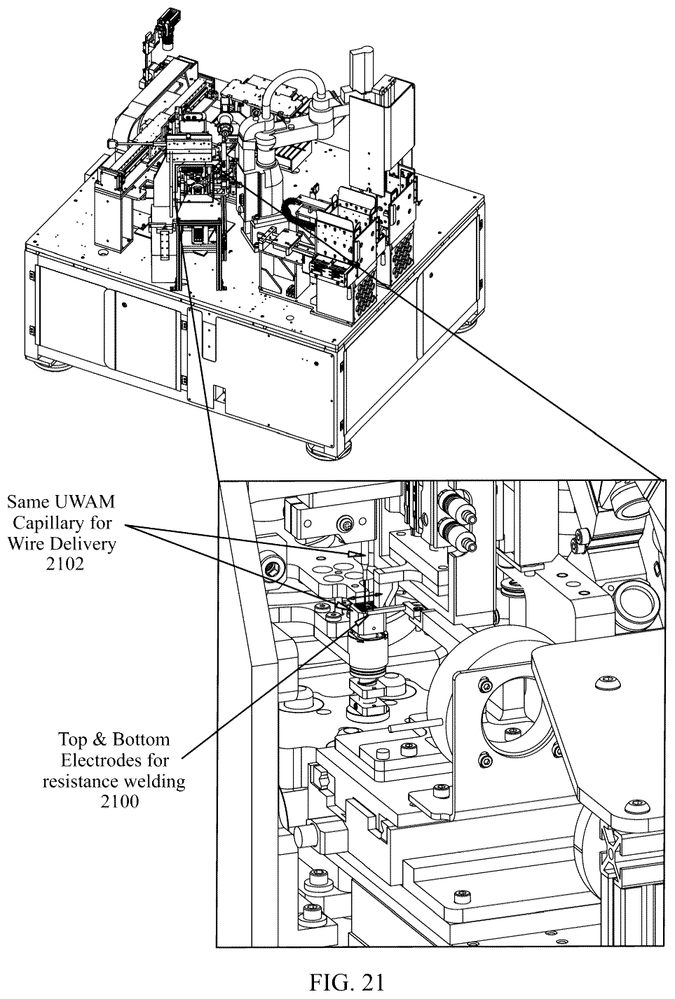

FIG. 21 illustrates that a precision stage carries a single electrode that welds both ends of the wire. By moving from the first position to the second position, the need for a second weld head can be eliminated. In FIG. 21, top and bottom electrodes for resistance welding 2100 and a UWAM capillary for wire delivery 2102 can be used in the present systems.

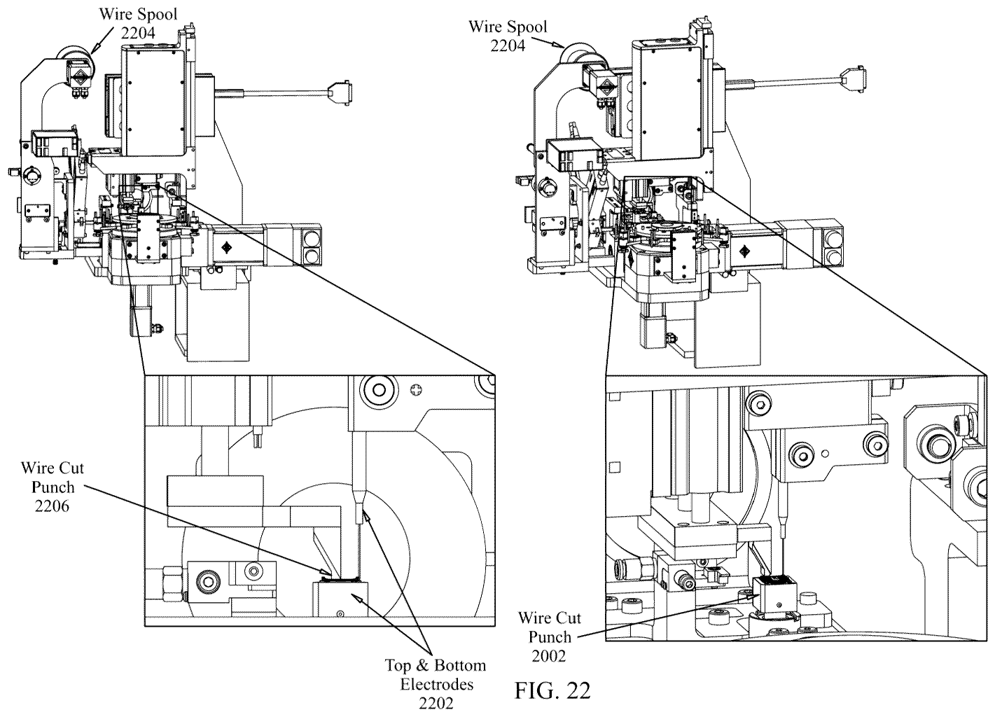

FIG. 22 illustrates that once the wire is welded to the work piece on both ends, a cut punch on a precision stage moves down and cuts the wire. In FIG. 22, a wire cut punch 2200, top and bottom electrodes 2202, a wire spool 2204, and a wire cut punch 2206 can be incorporated in the present systems.

### Material Science Testing

High reliability and long life is an expectation in the smartphone camera industry. The effects of resistance welding on SMA wire material properties are studied to insure SMA wires remain reliable when resistance welded. Since the SMA wire is very small, at 30 μm in diameter, nanoindenting is used to obtain the material properties.

Samples of welded wire are cross sectioned and polished. A Nanomechanical Test System can apply a load of 2,000 μN to nanoindent samples while scanning probe microscopy (SPM) simultaneously measures the depth of the nanoindent. The load and depth are used to calculate nanohardness, H, and reduced elastic modulus, Er. Young's modulus can be calculated from reduced elastic modulus, Er through a relationship based on Poisson's Ratio.

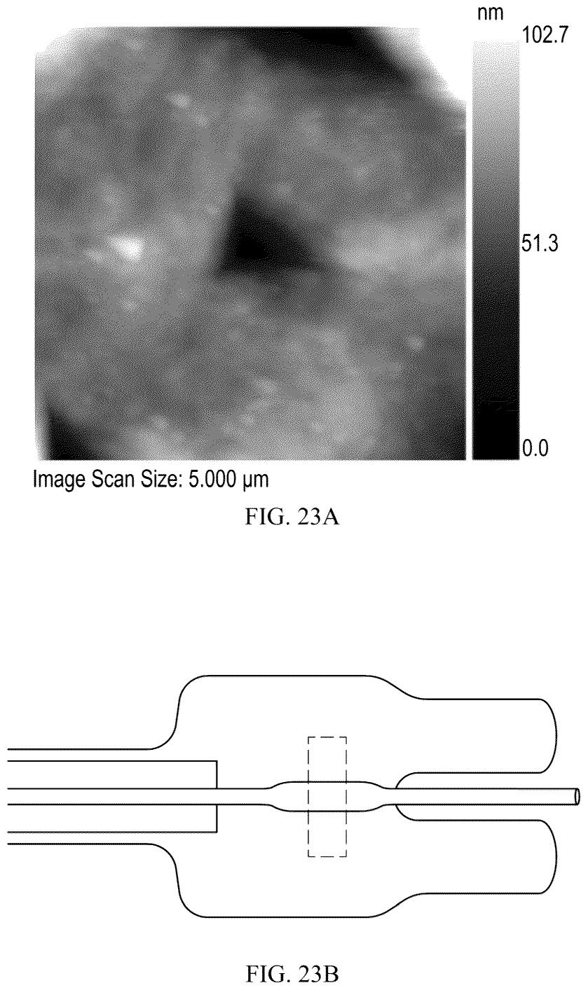

FIGS. 23A-B illustrates (a) a scanning probe microscopy (SPM) image of a nanoindent of a cross section of an SMA wire weld, and (b) Welded SMA wire with an area of cross section and nanoindent framed in white.

Nanohardness, H of as received wire is 4.249 GPa and increases to 4.875 GPa due to cold working when clamping the electrodes on the wire, but not applying any welding current. The heat generated when welding current is applied has an offsetting effect on the cold working and softens the wire back to 4.286 GPa. Resistance welding SMA wire can have a net result of nearly no change in nanohardness of the SMA wire.

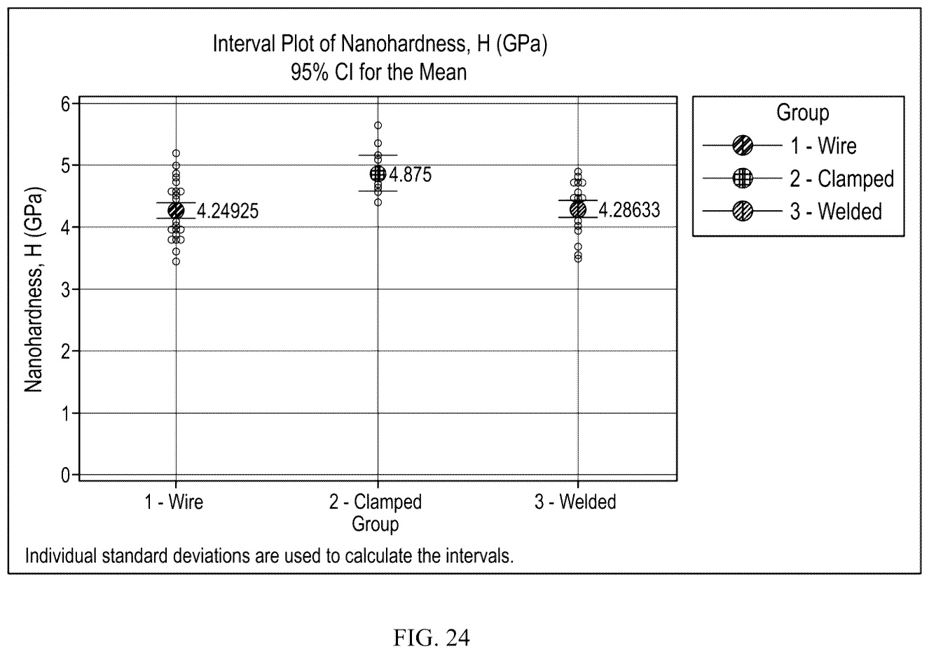

FIG. 24 is an example graph illustrating Nanohardness, H of as received wire is 4.249 GPa and increases due to cold working when clamping the electrodes on the wire, but not applying any welding current. The heat generated when welding current is applied has an offsetting effect on the cold working and softens the wire, the net result being nearly no change in nanohardness.

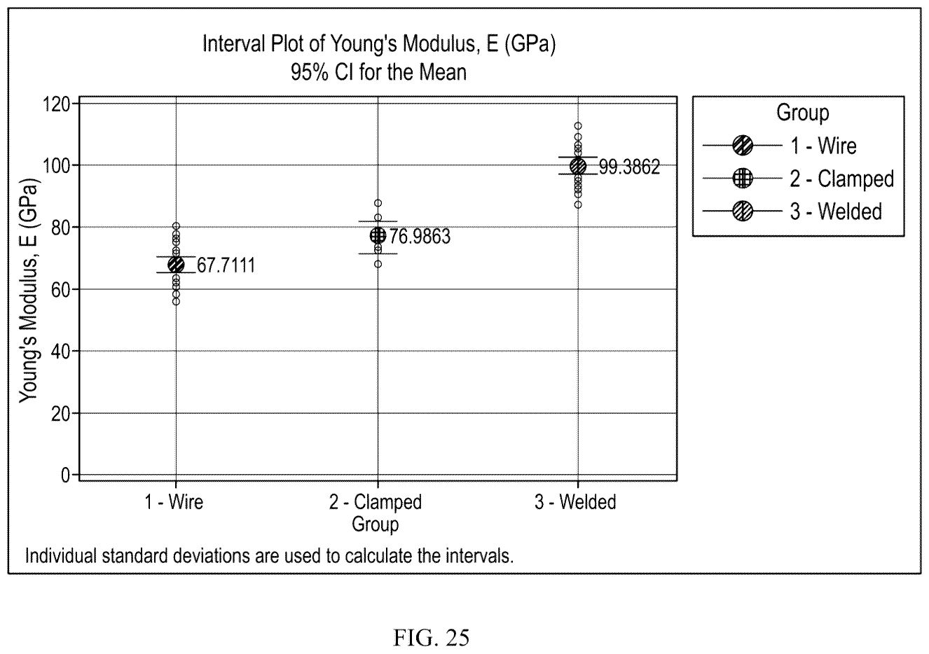

FIG. 25 is an example graph of a Young's Modulus, E on as received wire is 67.711 GPa. After clamping the electrodes on the wire, but not applying any welding current, the modulus can increase to 76.986 GPa. When the wire is clamped and welded, the modulus is 99.386 GPa. Modulus does not normally increase with cold working (clamping) or heating (resistance welding). SMA in the austenite phase does have a significantly higher modulus than martensite suggesting that the cold working and heating from resistance welding the wire causes it to transition to a higher percentage of austenite resulting in a higher modulus. SMA wire being used for smartphone actuators is likely starts with some proportion of austenite due to the drawing and training process used to manufacture the wire, which may explain why the modulus of wire as received is 67.711 GPa, and not in the 28-41 GPa range of fully martensite nitinol (see reference data in table 4).

Table 4 Elastic Modulus of SMA2 in austenite and martensite phases.

$$Elastic Modulus of SMA \frac{\begin{matrix}Austenite Phase & Martensite Phase\end{matrix}}{\begin{matrix}Approx . 83 GPa & Approx . 28 - 41 GPa\end{matrix}}$$

Nanoindenting shows that resistance welding SMA has an effect on the material properties. The modulus of SMA wire within the weld is 40% higher than as received wire. Based on life test results (refer to FIG. 12), this increase is acceptable, as the life test shows wire welding is reliable in application. These nanoindent results serve as a baseline to compare future nanoindent results and predict life cycle performance as wire welding is applied to designs.

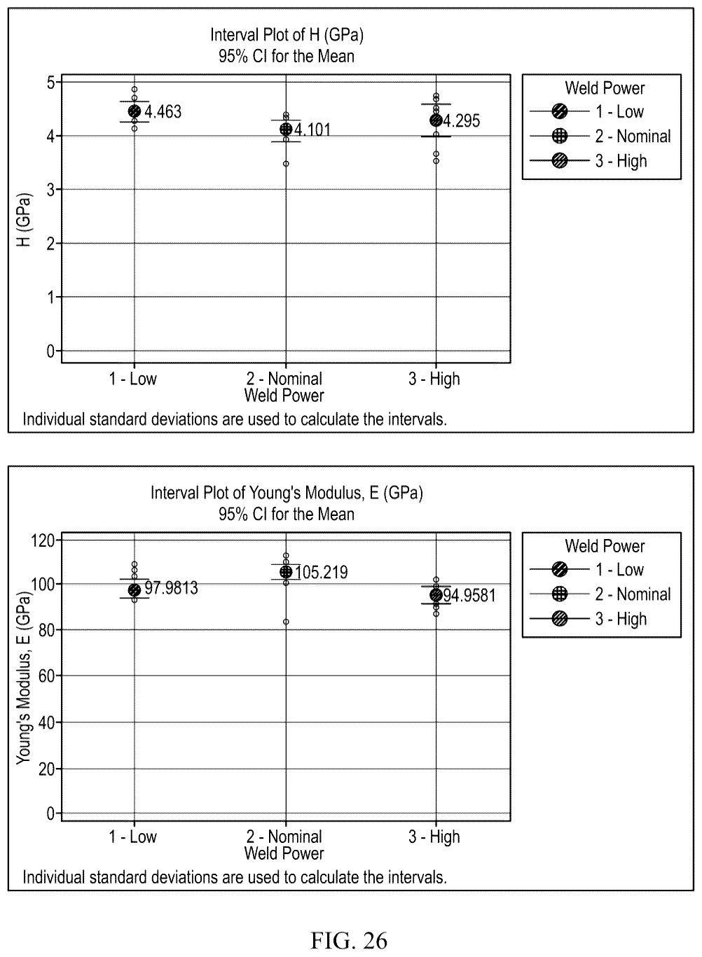

Nanoindenting can be used to measure nanohardness and modulus on samples welded with different settings as a limits test, to show robustness to process variation. Low, nominal, and high weld current (amperage) settings are used to make samples that are nanoindented to obtain nanohardness and Young's modulus. The results in FIG. 26 show material properties are similar for low, nominal, and high weld energy, making wire welding tolerant of mass production levels of welder variation.

FIG. 26 illustrates example graphs illustrating that material properties can be similar for low, nominal, and high weld energy, making wire welding tolerant of mass production levels of welder variation.

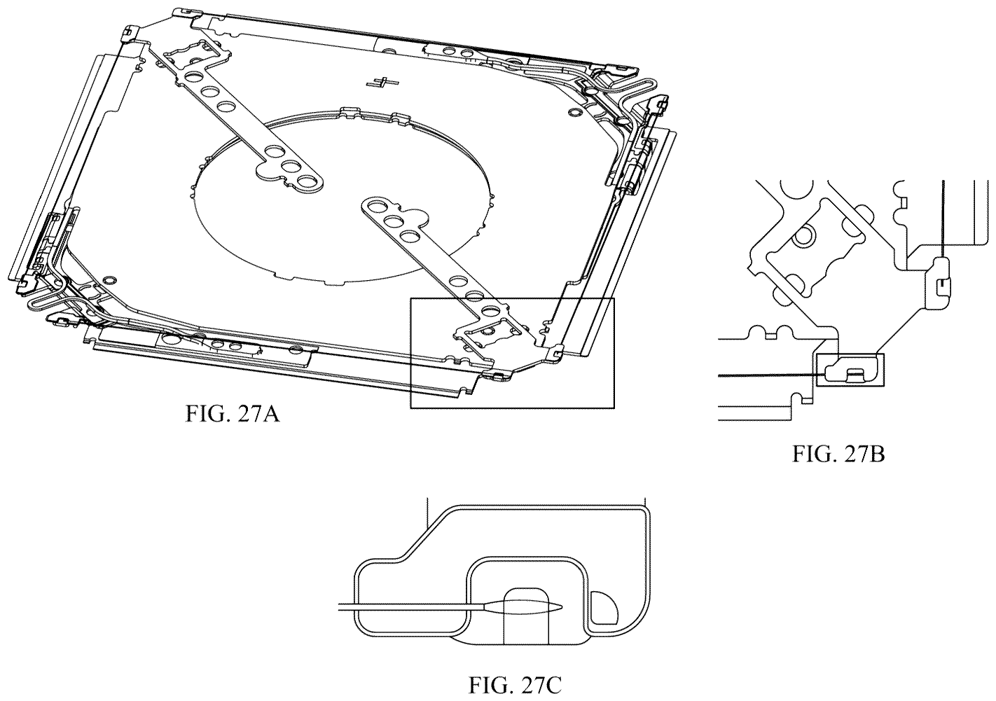

FIGS. 27A-C illustrates (a) SMA OIS platform development part used to test reliability of SMA wire welds; (b) SMA OIS platform development part with SMA wire welds; (c) SMA wire weld.

Shock performance is evaluated in a free fall drop test. Two OIS actuators are placed in a simulated smartphone handset and dropped four times on each edge and both faces for 24 total drops from a height of 1.6 m onto a concrete floor.

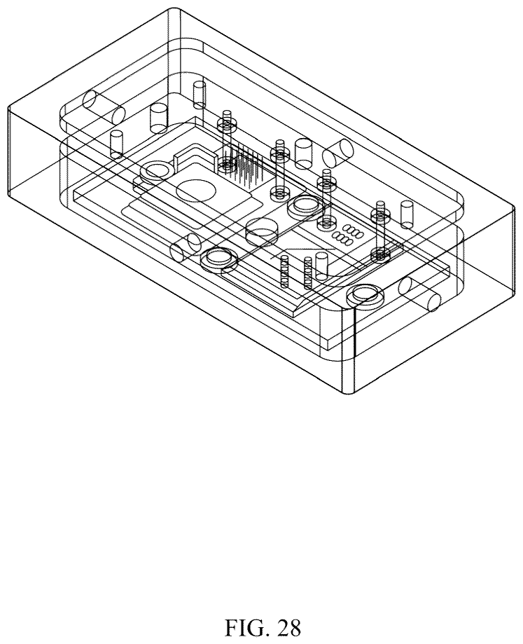

FIG. 28 illustrates two OIS actuators are placed in a simulated smartphone handset and dropped from a height of 1.6 m onto a concrete floor.

The resistance welded wires remain intact and pass the drop test. A passing result is indicated by resistance in the SMA wires of 26-28 ohms. Failing parts will have an open circuit on one or more of the wire circuits indicating one of the wires has broken.

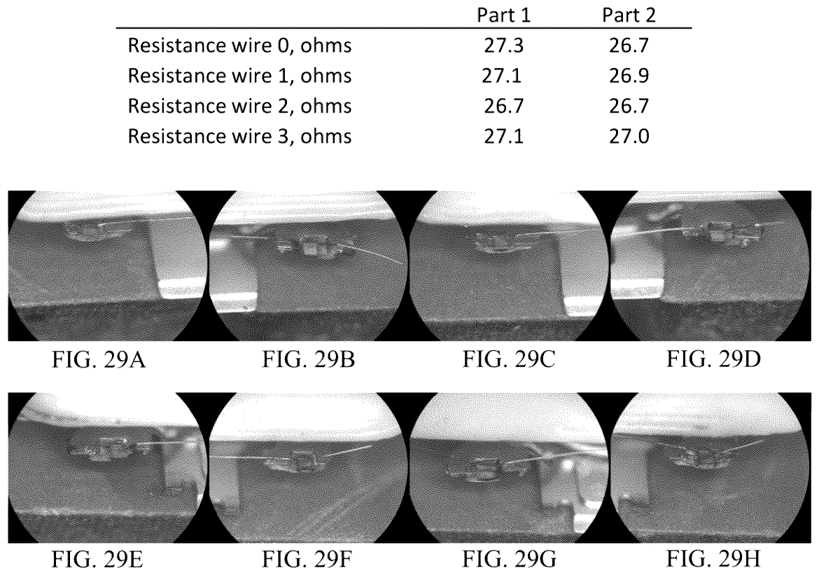

FIGS. 29A-H illustrates that SMA wire welds on OIS platform development parts pass drop test.

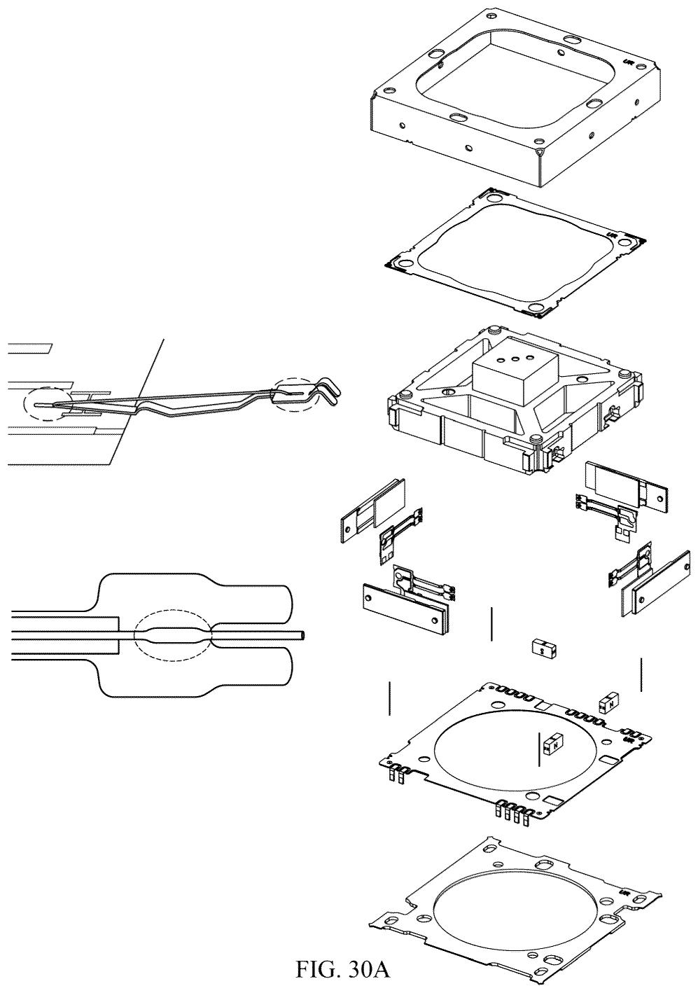

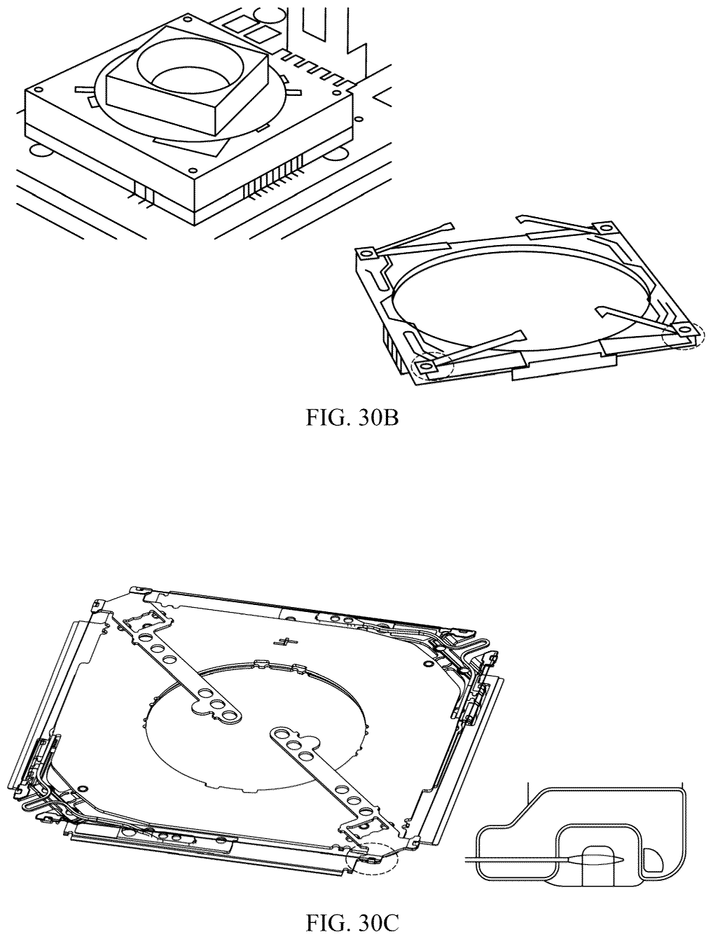

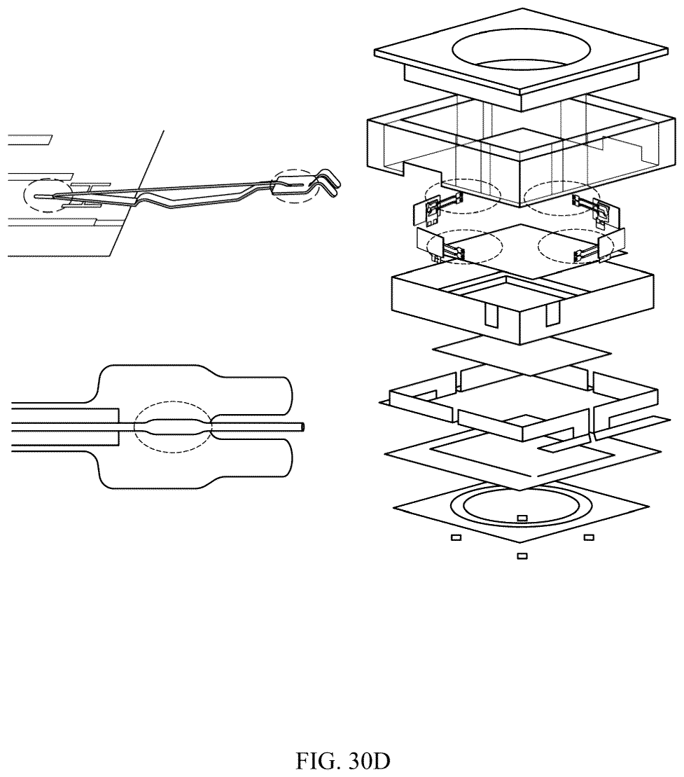

FIGS. 30A-D illustrates that SMA wire welding is going forward in application on products including (a) HTI Bimorph™ lens shift OIS, (b) Buckler AF, (c) OIS long wire platform development, and (d) Bimorph sensor shift OIS.

The SMA wire resistance welding process can be a reliable solution for attaching SMA wires to camera module actuators. A resistance welder with improved capability can be deployed. The baseline resistance welding process can be established. SMA wire welds are shown to be strong in pull tests and reliable to one million cycles in life tests. Electrode sticking issues were resolved by changing the bottom electrode material. Dynamic mechanical analysis shows SMA wire welded to steel coupons behaves more similarly to “as received” wire than wire that had been annealed red hot. Mechanical properties of resistance welded SMA wire are measured with the use of nanoindenting and scanning probe microscopy and provide a baseline hardness and Young's Modulus of welded SMA wire for comparing to on future applications. Passing life cycle and drop shock tests show welded SMA wire is reliable in application.

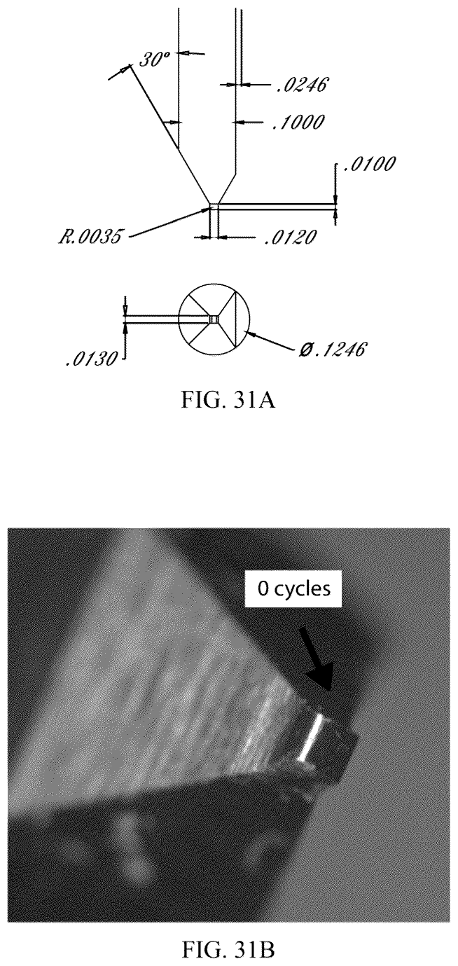

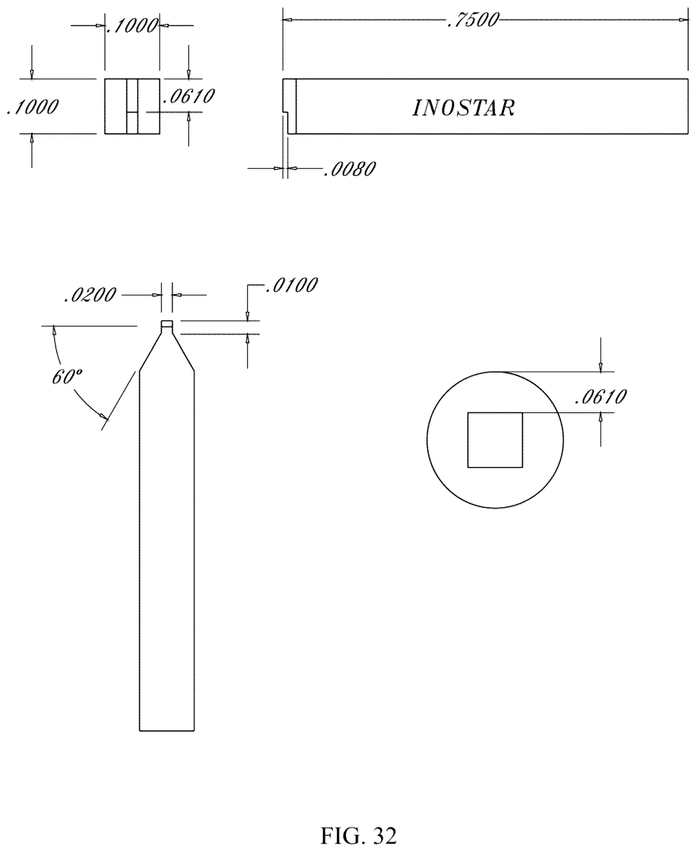

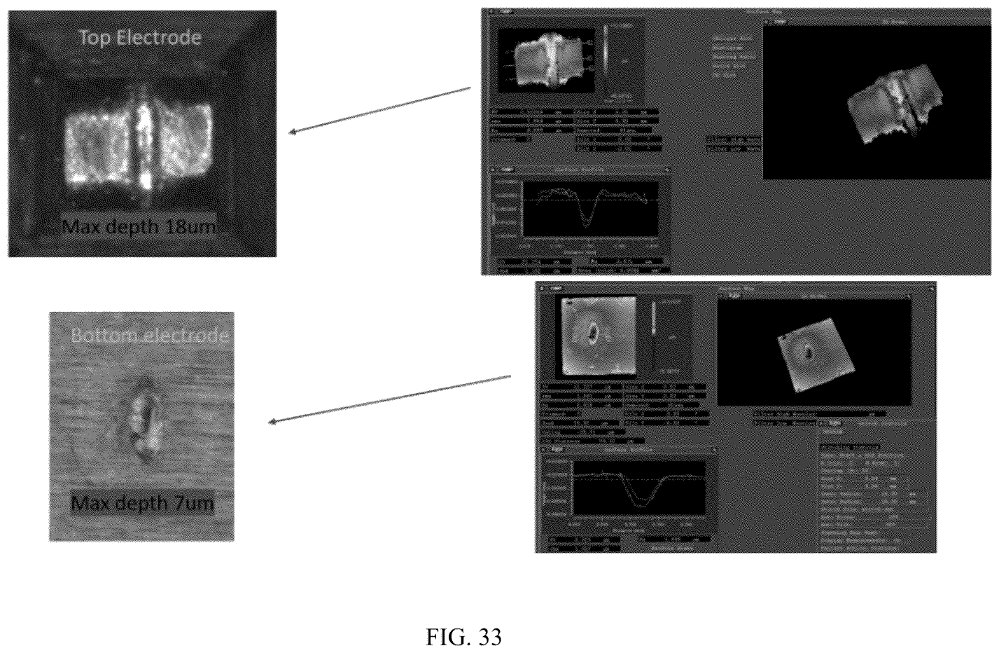

FIGS. 31A-B illustrate top electrode dimensions as tested. FIG. 32 illustrates bottom electrode dimensions as tested. FIG. 33 illustrates example electrodes with 1500 weld cycles in static location burn in depth.

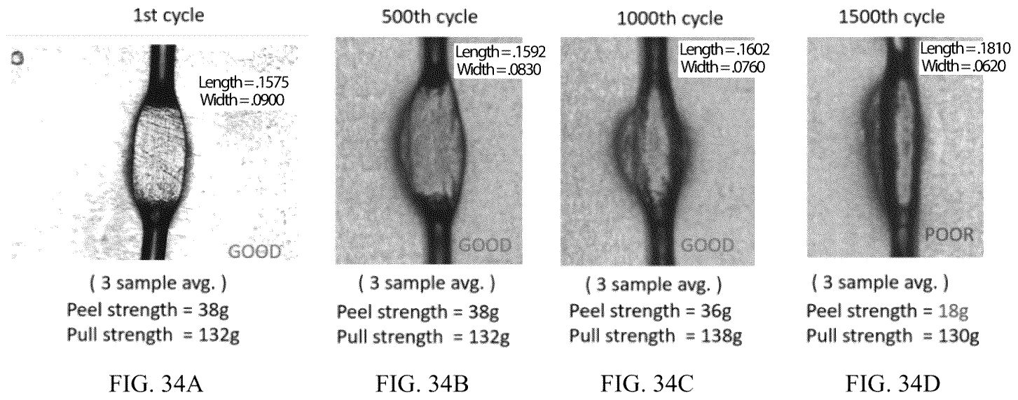

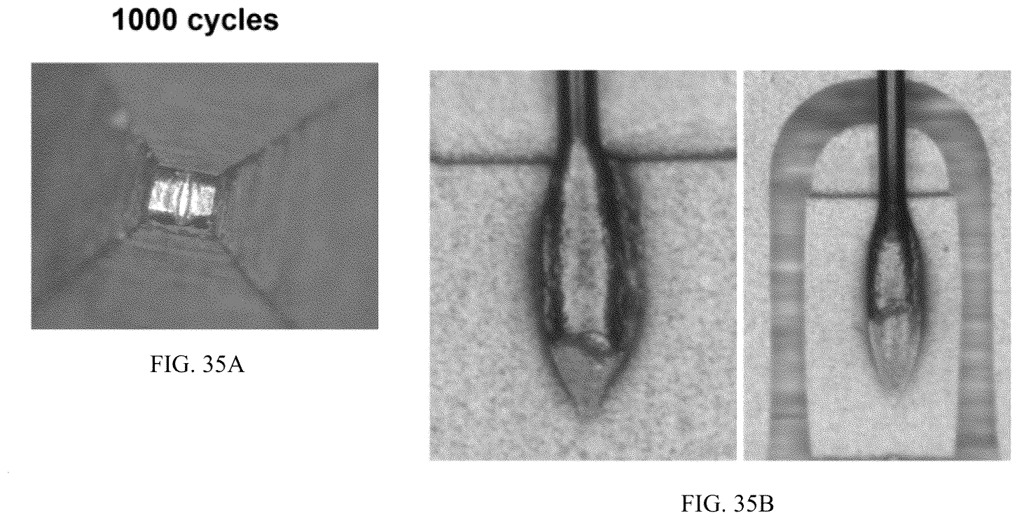

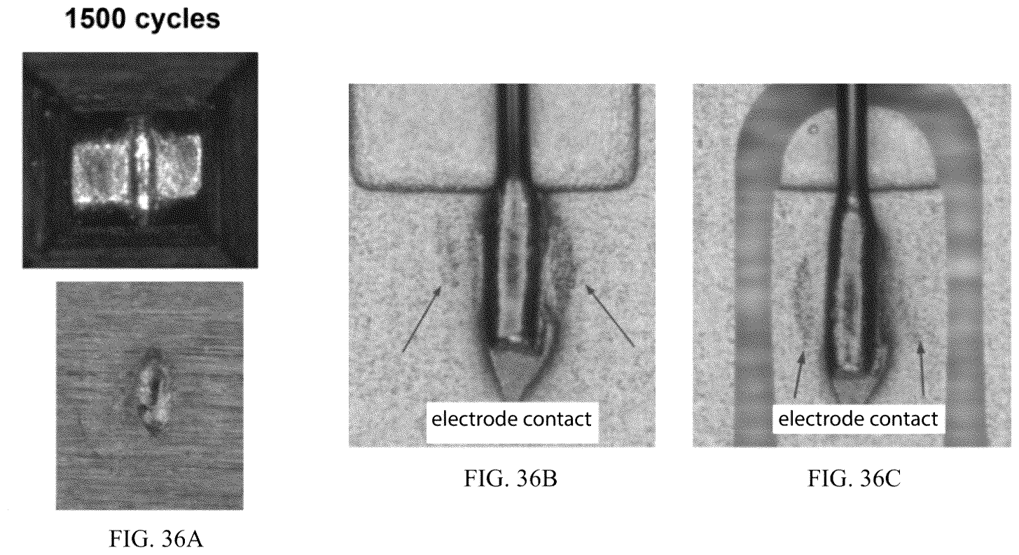

FIGS. 34A-D illustrate example static welds. FIGS. 35A-B illustrate examples for 1000 cycles. FIGS. 36A-C illustrate examples for 1500 cycles.

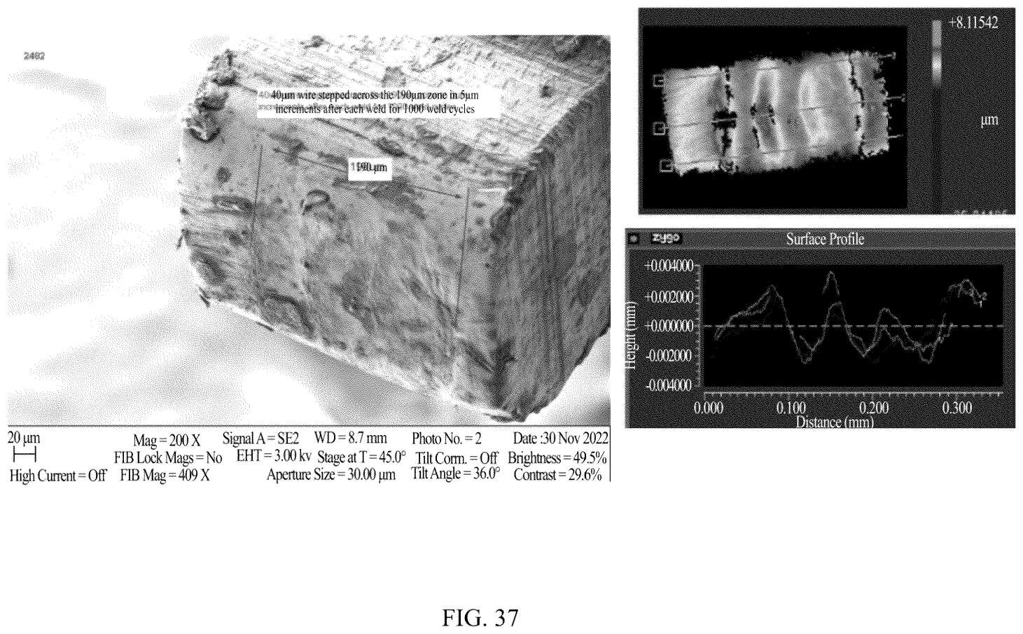

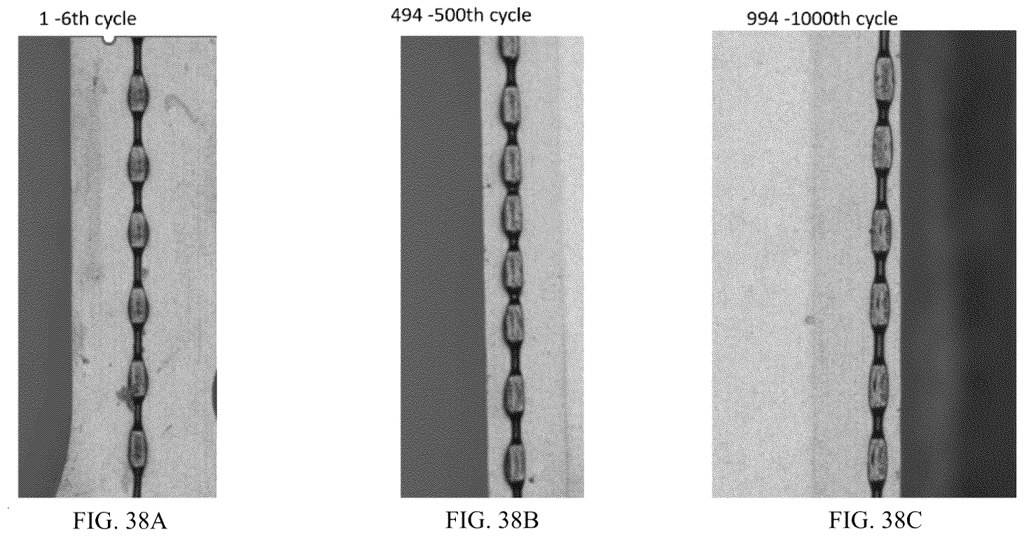

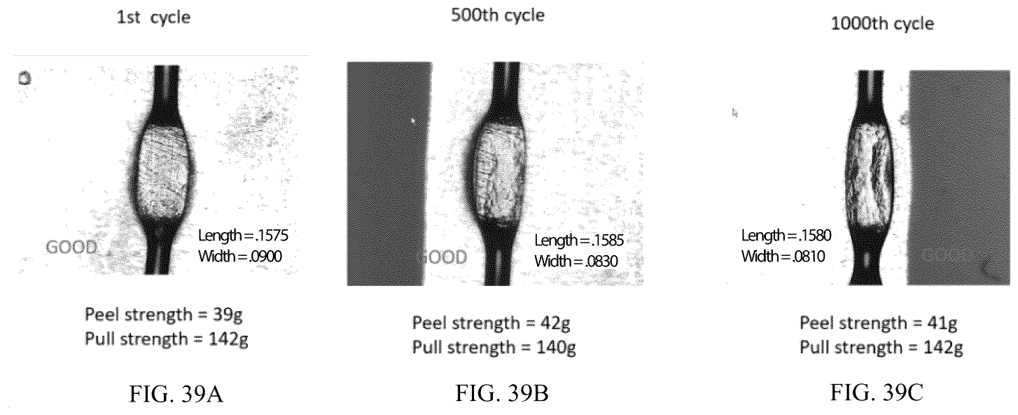

FIG. 37 illustrates example stepped welding with 4 um deviation across electrode surface at 1000 cycles. FIGS. 38A-C illustrate example stepped welding from 1-1000 cycles. FIGS. 39A-C illustrate example stepped welding measurements.

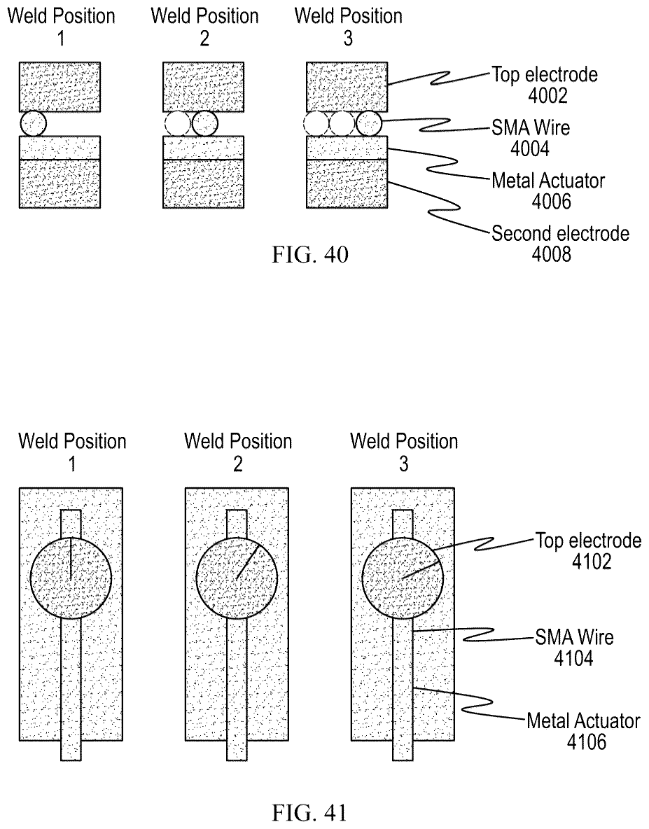

FIG. 40 illustrates an example set of weld positions as part of a resistance welding technique. As shown in FIG. 40, a SMA wire can be positioned in different weld positions relative to a top electrode 4002, SMA wire 4004, a second electrode 4008, and a metal actuator 4006.

In some instances, the electrodes can be disposed to an adjacent position that is about 4 micrometers from a previous welding position to distribute wear of electrode material during weld cycles to make electrode wear more uniform and increase a number of cycles between stoppages to resurface electrode faces. The disposing of electrodes can be repeated to another adjacent position that is about 4 micrometers from the previous welding position and about 8 micrometers from the first welding position.

FIG. 41 illustrates an example set of weld positions capable of being rotated. For example, in FIG. 41, at each weld position, the electrodes can be rotated. The top electrode 4102 can be disposed adjacent to the SMA wire 4104 and the second electrode of the resistance welder can be disposed adjacent to the metal actuator 4106. The electrodes can be disposed to an adjacent position that is rotated about 10 degrees from a previous welding position to distribute wear of electrode material during weld cycles to make electrode wear more uniform and increase a number of cycles between stoppages to resurface electrode faces. The disposing of electrodes can be repeated to another adjacent position that is about 10 degrees from the previous welding position and about 20 degrees from the first welding position.

In some instances, a method for performing a resistance welding process between a metal actuator and a shape memory alloy (SMA) wire is provided. The method can include positioning a resistance welder at a first end of the SMA wire and the metal actuator such that a top electrode is disposed adjacent to the SMA wire and a second electrode of the resistance welder is disposed adjacent to the metal actuator. An electrode material can include a tungsten alloy that includes an increased resistance to a resistance of tungsten copper.

The method can also include performing, by the resistance welder, a first resistance weld at the first end of the SMA wire and the metal actuator by passing a current through the SMA wire and the metal actuator. The method can also include positioning the resistance welder at a second end of the SMA wire and the metal actuator such that the top electrode is disposed adjacent to the second end of the SMA wire and the second electrode of the resistance welder is disposed adjacent to the second end of the metal actuator. The method can also include performing, by the resistance welder, a second resistance weld at the second end of the SMA wire and the metal actuator by passing the current through the SMA wire and the metal actuator, wherein each of the first and second resistance welds are performed for a weld pulse duration of around 9 milliseconds (ms).

In some instances, performing each of the first and second resistance welds include, between each weld pulse duration, a 2 ms ramp up and a 2 ms ramp down period, wherein a pulse current of each of the first and second resistance welds is around 110 amps.

In some instances, the metal actuator comprises stainless steel.

In some instances, the resistance welder includes step sizes of power of around 0.001 watt-seconds (W-s), a lower total power, a pulse time step size of around 0.1 ms and around 1 ms, step sizes of electrode clamp force of around 0.1 pounds (lbs), and lower time to time variability.

In some instances, the method can also include obtaining a set of coupons of 0.004 inches thick comprising 302 stainless steel, performing a resistance weld on each of the coupons to SMA wires at weld strengths between 25-35 grams with weld energies between 2.2 to 4 watt-seconds for a pulse duration of around 10 ms, and testing one or more conditions of the set of coupons to determine well peel strength of the coupons and wires attached to each of the coupons.

In some instances, testing the one or more conditions further includes performing, using a focused ion beam (FIB), a cross-section of welds on each of the coupons.

In some instances, the method can also include performing a nanoindenting process to the SMA wire to measure a nanohardness and modulus on samples welded with different settings.

In some instances, the metal actuator is part of an optical image stabilization system.

In some instances, the top electrode is disposed adjacent to the SMA wire and the second electrode of the resistance welder is disposed adjacent to the metal actuator, wherein the electrodes are disposed to an adjacent position that is about 4 micrometers from a previous welding position to distribute wear of electrode material during weld cycles to make electrode wear more uniform and increase a number of cycles between stoppages to resurface electrode faces, wherein the disposing of electrodes is repeated to another adjacent position that is about 4 micrometers from the previous welding position and about 8 micrometers from the first welding position.

In some instances, the top electrode is disposed adjacent to the SMA wire and the second electrode of the resistance welder is disposed adjacent to the metal actuator, wherein the electrodes are disposed to an adjacent position that is rotated about 10 degrees from a previous welding position to distribute wear of electrode material during weld cycles to make electrode wear more uniform and increase a number of cycles between stoppages to resurface electrode faces, wherein the disposing of electrodes is repeated to another adjacent position that is about 10 degrees from the previous welding position and about 20 degrees from the first welding position.

One skilled in the art would understand that other dimensions and materials could be used to meet desired design characteristics.

According to some embodiments, the processes described herein are used to form one or more of any of mechanical structures and electro-mechanical structures.

Although described in connection with these embodiments, those of skill in the art will recognize that changes can be made in form and detail without departing from the spirit and scope of the invention.

What is claimed is:

1. A method for performing a resistance welding process between a metal actuator and a shape memory alloy (SMA) wire, the method comprising:
positioning a resistance welder at a first end of the SMA wire and the metal actuator such that a top electrode is disposed adjacent to the SMA wire and a second electrode of the resistance welder is disposed adjacent to the metal actuator, wherein an electrode material is a tungsten alloy that includes an increased resistance to a resistance of tungsten copper;
performing, by the resistance welder, a first resistance weld at the first end of the SMA wire and the metal actuator by passing a current through the SMA wire and the metal actuator;
positioning the resistance welder at a second end of the SMA wire and the metal actuator such that the top electrode is disposed adjacent to the second end of the SMA wire and the second electrode of the resistance welder is disposed adjacent to the second end of the metal actuator; and
performing, by the resistance welder, a second resistance weld at the second end of the SMA wire and the metal actuator by passing the current through the SMA wire and the metal actuator, wherein each of the first and second resistance welds are performed for a weld pulse duration of around 9 milliseconds (ms).

2. The method of claim 1, wherein performing each of the first and second resistance welds include, between each weld pulse duration, a 2 ms ramp up and a 2 ms ramp down period, wherein a pulse current of each of the first and second resistance welds is around 110 amps.

3. The method of claim 1, wherein the metal actuator comprises stainless steel.

4. The method of claim 1, wherein the resistance welder includes step sizes of power of around 0.001 watt-seconds (W-s), a lower total power, a pulse time step size of around 0.1 ms and around 1 ms, step sizes of electrode clamp force of around 0.1 pounds (lbs), and lower time to time variability.

5. The method of claim 1, further comprising:
obtaining a set of coupons of 0.004 inches thick comprising 302 stainless steel;
performing a resistance weld on each of the coupons to SMA wires at weld strengths between 25-35 grams with weld energies between 2.2 to 4 watt-seconds for a pulse duration of around 10 ms; and
testing one or more conditions of the set of coupons to determine well peel strength of the coupons and wires attached to each of the coupons.

6. The method of claim 5, wherein testing the one or more conditions further includes:
performing, using a focused ion beam (FIB), a cross-section of welds on each of the coupons.

7. The method of claim 1, further comprising:
performing a nanoindenting process to the SMA wire to measure a nanohardness and modulus on samples welded with different settings.

8. The method of claim 1, wherein the metal actuator is part of an optical image stabilization system.

9. The method of claim 1, wherein the top electrode is disposed adjacent to the SMA wire and the second electrode of the resistance welder is disposed adjacent to the metal actuator, wherein the electrodes are disposed to an adjacent position that is about 4 micrometers from a previous welding position to distribute wear of electrode material during weld cycles to make electrode wear more uniform and increase a number of cycles between stoppages to resurface electrode faces, wherein the disposing of electrodes is repeated to another adjacent position that is about 4 micrometers from the previous welding position and about 8 micrometers from the first welding position.

10. The method of claim 1, wherein the top electrode is disposed adjacent to the SMA wire and the second electrode of the resistance welder is disposed adjacent to the metal actuator, wherein the electrodes are disposed to an adjacent position that is rotated about 10 degrees from a previous welding position to distribute wear of electrode material during weld cycles to make electrode wear more uniform and increase a number of cycles between stoppages to resurface electrode faces, wherein the disposing of electrodes is repeated to another adjacent position that is about 10 degrees from the previous welding position and about 20 degrees from the first welding position.
